(19) United States
(12) Patent Application Publication
(10) Pub. No.: US 2020/0125964 A1
(43) Pub. Date: Apr. 23, 2020

(54) PREDICTING SUCCESSFUL COMPLETION OF A DATABASE UTILITY PROCESS WITHIN A TIME FRAME HAVING CONCURRENT USER ACCESS TO THE DATABASE

(71) Applicant: CA, Inc., Islandia, NY (US)

(72) Inventors: Robin Hopper, Prague (CZ); Alexander H. Kingham, Praha 8 (CZ); Jan Svec, Praha 10 (CZ)

(73) Assignee: CA, Inc., Islandia, NY (US)

(21) Appl. No.: 16/166,049

(22) Filed: Oct. 19, 2018

(51) Int. Cl. G06N 5/02; G06F 17/30

(52) U.S. Cl. CPC G06N 5/022; G06F 17/30008

(57) ABSTRACT

An embodiment includes generating predicted workloads on an object within a time frame, identifying a first predicted workload on the object at a first time in the time frame, and determining, based on the first predicted workload of the object, whether a first stage of a utility process can be successfully executed for the object at the first time. The embodiment also includes making a prediction related to whether the utility process can be successfully completed when the utility process is initiated at the first time. The prediction is based, at least in part, on determining whether the first stage can be successfully executed at the first time.

### BACKGROUND

The present disclosure relates in general to the field of data storage, and more specifically, to predicting successful completion of a database utility process within a time frame having concurrent user access to the database.

Mass storage devices (MSDs) are used to store large quantities of data and to enable continuous or near-continuous access to the data. Retailers, government agencies and services, educational institutions, transportation services, web services, and health care organizations are among a few entities that may provide ‘always-on’ access to their data by customers, employees, students, or other authorized users. A database is a data structure used to store large quantities of data as an organized collection of information. Typically, databases have a logical structure such that a user accessing the data in the database sees logical data columns arranged in logical data rows. For some entities, any amount of time in which the database is ‘off-line’ is unacceptable. Thus, data utility processes are often scheduled during a quiet window of time when system activity is thought to be low. In an always-on database, however, even quiet windows of time may be filled with enough database activity to prevent successful completion of the utility processes. More effective techniques determining suitable times at which utility processes can be executed are needed.

### BRIEF SUMMARY

According to one aspect of the present disclosure, predicted workloads on an object within a time frame may be generated. A first predicted workload on the object at a first time in the time frame may be identified. Whether a first stage of a utility process can be successfully executed for the object at the first time may be determined based on the first predicted workload of the object. Based, at least in part, on determining whether the first stage can be successfully executed at the first time, a prediction related to whether the utility process can be successfully completed when the utility process is initiated at the first time can be made.

### BRIEF DESCRIPTION OF THE DRAWINGS

FIG. 1 is a simplified block diagram of an example of some components of a communication system for predicting successful completion of a database utility process within a time frame having concurrent user access to the database, according to at least one embodiment of the present disclosure.

FIG. 2 is a simplified block diagram illustrating additional details of certain components of the communication system according to at least one embodiment.

FIG. 3 is a simplified block diagram illustrating a time-series data extraction that the communication system may perform according to at least one embodiment.

FIG. 4 is a graph produced by a time-series workload model of example workloads on an object over a particular time frame according to at least one embodiment.

FIG. 5 is a simplified block diagram illustrating an example flow for learning information related to database utility processes in the communication system according to at least one embodiment.

FIGS. 6A-6C are simplified flowcharts of possible operations related to learning information related to utility processes to build a utility history repository for the communication system according to at least one embodiment.

FIG. 7 is a simplified block diagram illustrating an example flow of a prediction model for predicting successful completion of a utility process during a particular time frame in the communication system according to at least one embodiment.

FIGS. 8A-8C are simplified flowcharts of possible operations related to predicting successful completion of a utility process during a particular time frame in the communication system according to at least one embodiment.

FIG. 9 is a graphical illustration of the results of applying the prediction model to predict completion of a utility process on an object during a particular time frame according to at least one embodiment.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “module,” “component,” “element,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but is not limited to, an electronic, magnetic, optical, electromagnetic, or semiconductor system, apparatus, or device, or any suitable combination of the foregoing. More specific examples (a non-exhaustive list) of the computer readable storage medium include the following: a mass storage device (MSD), a Universal Serial Bus (USB) flash drive, a portable computer diskette, a hard disk, a random access memory (RAM), a read-only memory (ROM), a programmable read-only memory (PROM), an erasable programmable read-only memory (EPROM or Flash memory), an electrically erasable read only memory (EEPROM), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (RF), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, low-level programming languages such as assembly languages, conventional procedural programming languages, such as the “C” programming language, Visual Basic, Fortran 2003, Perl, COBOL 2002, PHP, ABAP, assembly language, dynamic or script programming languages such as Python, Ruby and Groovy, batch file (.BAT or .CMD), powershell file, REXX, or any format of data that can describe sequences (e.g., XML, JSON, YAML, etc.), or other programming languages. By way of example, the program code may execute entirely on a mainframe system, entirely on a database server, partly on a mainframe system and partly on a database server, partly on a mainframe system or database server and partly on a remote computer, partly on a mainframe system, a database server, and a remote computer, or entirely on a remote computer. In the scenarios involving a remote computer, the remote computer (e.g., server) may be connected to a mainframe system, a database server, and/or any other local computer through any type of network, including a local area network (LAN) or a wide area network (WAN), or the connection may be made through an external computer (for example, through the Internet using an Internet Service Provider) or in a cloud computing environment or offered as a service such as a Software as a Service (SaaS). Generally, any combination of one or more local computers and/or one or more remote computers may be utilized for executing the program code.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, can direct a computer, other programmable data processing apparatus, or other devices to function in a particular manner, such that the instructions when stored in the computer readable medium produce an article of manufacture including instructions that, when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses, or other devices to produce a computer implemented process such that the instructions, which execute on the computer, other programmable apparatuses, or other devices, provide processes for implementing the functions/acts specified in the flowchart and/or block diagram block or blocks.

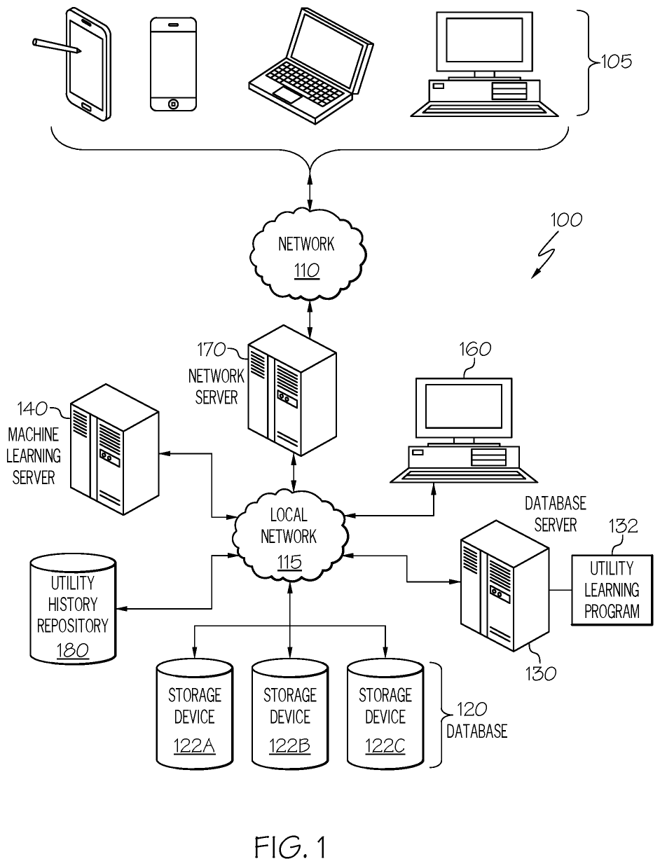

Referring now to FIG. 1, a simplified block diagram is shown illustrating an example communication system 100 for predicting successful completion of a database utility process within a time frame having concurrent user access to the database according to at least one embodiment. In communication system 100, a network 110 (e.g., a wide area network such as the Internet) may facilitate communication between user devices 105 and a network server 170. Network server 170 may be configured to communicate with one or more of a database server 130, a machine learning server 140, a database 120, a utility history repository 180, and a user terminal 160. In one implementation, such communication may be provided via a local network 115.

Network server 170 may be configured to enable access from user devices 105 to database server 130 and database 120, which can include one or more data storage devices, such as data storage devices 122A, 122B, and 122C. Although storage devices 122A-122C are shown as separate storage devices communicating with database server 130 via local network 115, it should be apparent that one or more of these storage devices may be combined in any suitable arrangement and that any or all of the storages devices 122A-122C may be connected to database server 130 directly or via some other network (e.g., wide area network, direct connection, etc.). Moreover, one or more of the components shown in FIG. 1 may be provided in a mainframe system in at least some implementations.

User devices 105 can enable users to interface with database server 130 and to consume data contained in database 120. User terminal 160 may be used to enable an authorized user, such as a Database Administrator (DBA), to communicate with and issue commands to database server 130 to access the database and/or to machine learning server 140. In other embodiments, user terminal 160 could be directly connected to database server 130 and/or machine learning server 140 or could be remotely connected to database server 130 and/or machine learning server 140 over the Internet, for example.

For purposes of illustrating certain example techniques of communication system 100 for predicting successful completion of a database utility process, it is important to understand the activities that may be occurring in a network environment that includes a database (e.g., 120) configured with data structures capable of hosting large quantities of data. The following foundational information may be viewed as a basis from which the present disclosure may be properly explained.

Data structures are used by storage devices (e.g., MSDs, DASDs) to store massive amounts of data across virtually every sector of society including, but not limited to, social media, business, retail, health, education, and government. A database generally refers to a collection of information organized in data structures such that the data can be easily accessed, managed, and updated. The concepts presented herein are applicable to any type of data structures used in storage devices. As used herein, ‘database’ is intended to include any type of data structure used for accessing, managing, and updating data in storage devices. Therefore, the discussion herein references databases for ease of illustration; however, it should be understood that the concepts are applicable more generally and, as used herein, the term ‘database’ is intended to represent any type of data structure for storing large quantities of data that can be accessed, managed, and updated.

A typical database may include multiple objects. As used herein, an ‘object’ is intended to include any data structure (or format) for organizing, managing, and storing data to enable access and modification of the data. Examples of objects include, but are not necessarily limited to, tablespaces and index spaces. A tablespace can be embodied as a file containing raw data, some of which can be application data and some of which can be used internally to help manage the data. In one example tablespace, logical data columns can be arranged in logical data rows within the tablespace. These logical data columns can be stored as a logical data table. In some implementations, a logical data table (also referred to herein as ‘table’) may be viewable and potentially modifiable by a user online.

Like a tablespace, an index space can also be embodied as a file containing raw data. An index space, however, may be defined for a particular data table. Moreover, in at least one implementation, an index space may contain a single index for a single data table. One or more selected logical data columns from the data table may be arranged in a desired order in logical data rows within an index space. These logical data columns within the index space may be stored as a logical index (also referred to herein as ‘index’) and contain the data from those columns in the data table. The index can also include pointers to rows in the data table. Various types of indexes may be created. For example, a unique index may ensure that the value in a particular column or set of columns is unique, a primary index may be a unique index on the primary key of the table, a secondary index may be an index that is not the primary index, a clustering index may ensure a logical grouping, and an expression-based index may be based on a general expression. Other index types may be applicable to particular types of tables (e.g., partitioned tables, XML tables, etc.).

A database may also maintain a catalog of information about the data stored in the database. In at least some examples, this catalog of information may be implemented as a set of tables in the database. Catalog tables may contain information about database objects including tables, indexes, tablespaces, and index spaces. In one example, a catalog table may contain information about objects that are of the same type. Each row of the catalog table contains information about a different object of that type. This information can describe the structure of the object and tell how the object relates to other objects, including different types of objects.

Data rows can be loaded into a tablespace in a native sequence, which is a sequence that is specified for data rows. Often, a preferred sequence is selected by an entity (e.g., a DBA of the entity) based on the likely performance impact of the selected sequence relative to other possible sequences. In at least some implementations, the native sequence may correspond to the most likely processing order of the data rows. If data requests (e.g., user requests, batch utility process requests) are typically made in a particular order, then the performance of the database may increase if data rows are stored in the dataset in the order of the most common data requests to the least common data requests. In an example scenario, some databases related to human resources of an entity (e.g., enterprise, educational institution, governmental organization, etc.) may store information associated with each employee of the entity. In this scenario, if most user and/or batch requests are made based on particular employees, then the native sequence may be based on an employee identifier (employee ID) contained in each data row. In at least some implementations a key value indicating a place in the native sequence corresponds to each data row.

When a database is accessed and updated by users, however, its data rows do not remain in their native sequence. Each data row addition and each data row deletion can impact the sequence of the data rows and cause the actual sequence to deviate from the native sequence. Many databases offer 24/7 access to users and datasets may be continuously updated by those users. Consequently, over time, a dataset can become increasingly out-of-sequence. Reorganization of a tablespace (e.g., in native sequence) is often needed to improve performance. Similarly, index spaces may become out of order or otherwise corrupted by an application. Thus, index spaces may need to be repaired by, for example, reading the tablespace and rebuilding the index from the information in the tablespace.

A Database Administrator (DBA) typically uses data utility programs to perform maintenance on a database to enable more efficient accesses to the database by reorganizing a tablespace or correcting a corrupt index, for example. In past decades, entities seeking to reorganize their tablespaces back to native sequence (or to a new native sequence) or rebuild their index spaces typically had certain windows of opportunity when their databases would go off-line (e.g., for periodic maintenance, etc.) and would be inaccessible to users. As the interconnected world has evolved, however, many applications no longer have a scheduled off-line period. Rather, many consumers and other users expect 24/7 access to online data needed to conduct business, purchase goods, manage finances, access services (e.g., transportation, etc.), etc. Although most databases benefit in performance from periodic or regular reorganization, often the user data in the out-of-sequence tablespaces and index spaces cannot be taken off-line.

Accordingly, reorganization utility programs and index rebuilding programs have evolved to enable online reorganization of a tablespace or rebuilding of an index space. Reorganization and rebuilding processes may nevertheless require significant resources to complete their intended functions. Thus, it is typically desirable to run these programs during time frames when the activity on the system is low to minimize the disruption to users that access the database and to maximize the likelihood that the utility program will be completed. For many databases, however, even periods of time that experience lower system activity may be too busy to successfully complete a reorganization or rebuilding utility process.

Generally, problems may occur during the execution of a utility process at three different points in the execution. First, at the start of a reorganization or rebuilding process, the object being reorganized or rebuilt is taken off-line for a short amount of time (e.g., fraction of a second). This may be done to stop any new transactions on the object and to allow in-progress transactions to complete. Thus, when the object is started, there is a clean point in the log of database updates that delineates the start of the reorganization or rebuilding process. Although a user may see an insignificant delay (e.g., ½ second) between the stopping and starting of the object, if the workload on the database is too high, the object cannot be taken off-line even for this small amount of time. In this scenario, the beginning stage of the reorganization or rebuild process may fail. The technique of stopping an object and then starting it again is referred to as ‘quiesce’. Also, it should be noted that in some cases, an object such as a tablespace or an index space may be taken off-line without impacting the entire database. In other cases (e.g., one-part database or non-partitioned indexes) the entire database may be taken off-line when the object is taken off-line.

Second, the reorganization or rebuilding process creates a copy of the object's live data to be reorganized or rebuilt while the database is (potentially) being continuously updated by users. A log record may be stored in a log file for each update to the database. The process can read the log records to apply the updates to the copy of the object while it is being reorganized or rebuilt. If the log records are being written at certain rate by a log writer, however, the reorganization or rebuilding process may not be able to process the log records faster than they are being written to the log file. In this scenario, the processing stage (or middle stage) of the reorganization or rebuilding process may fail.

Third, if the processing stage is successfully executed, then the object has to be quiesced again. That is, the object is taken off-line for a small amount of time (e.g., fraction of a second) in order to switch the newly reorganized tablespace or rebuilt index space with the old tablespace or index space. If the workload on the database is too high, the object cannot be taken off-line even for this small amount of time and, in this scenario, the end stage of the reorganization or rebuild process may fail. Additionally, the reorganized tablespace or rebuilt index space may be updated with any few remaining log records that have not been processed. Typically, a time limit may be specified to enable the remaining records to be processed. Thus, if the number of remaining log records is too great, or if other processing issues occur during this final update, the reorganization or rebuilding process may fail.

The possible fail points in a typical reorganization or rebuilding process can cause tremendous frustration for users tasked with managing and maintaining the database. For example, such processes may initiate and fail at the end stage after running for several hours. The attempted reorganization or rebuild consumes resources without providing any benefit when these failures occur. In some cases, failures can occur repeatedly.

A communication system, such as communication system 100 for predicting successful completion of a database utility process within a time frame having concurrent user access to the database, as outlined in the FIGURES, can resolve these issues and others. In one example, predicting successful completion of a database utility process can include three phases. First, a series of utility reporting processes can be run against an object of a database to learn the parameters of a particular utility process (e.g., reorganization process, rebuild process) at different stages when it is run against the object. Second, a time-series machine learning algorithm may be used to create a time-series workload model to predict the workloads of the object at various times of the day, week, month, and year. Third, a prediction model evaluates the learned parameters of the database utility process (e.g., reorganization or rebuilding) against predicted workloads of the object over a given time frame that are generated from the time-series workload model.

In the first phase, reporting process can simulate certain operations of a regular utility process. In one example, a beginning stage and an end stage of a reorganization or rebuilding utility process applied to an object can be simulated by the reporting process. The respective workloads of the system during the simulated stages are determined and recorded in a utility history repository (e.g., a table) along with respective indications as to whether the executions of the simulated stages were successful. A middle stage of the regular utility process includes the main function of the process (e.g., reorganizing a tablespace, rebuilding an index space) and may not be simulated. Instead, log records of the database may be monitored over the normal execution time (e.g., based on the size of the object being reorganized or rebuilt by the utility process) of this middle stage of the regular utility process and evaluated to determine whether the middle stage is likely to be successfully executed or not likely to be successfully executed if executed at that particular time. The workload information, the indication of execution success or failure at each stage, and the size of the object may be stored in the utility history repository.

In the second phase, time-series analysis may be performed on log records associated with the object to create a time-series workload model. In one example, an autoregressive integrated moving average (ARIMA) may be used to create the time-series workload model that can predict future workloads on the object over a particular time frame. The predictions may be realized as a graph of predicted system workloads on an object by time in a particular time frame. The workload model can be used to generate workload predictions over a time frame that covers a quiet window in the system.

In a third phase, for a specified object and a specified utility program, the prediction model can be applied to the time-series predicted workloads of the object and a history of utility process evaluations for the object. The prediction model can identify predicted workloads that coincide with successful utility program executions against the object, workloads that coincide with unsuccessful utility program executions against the object, workloads that are within a threshold of an upper limit for successful utility program executions, and workload for which a utility program execution is unknown. Using the predictions produced by the workload model, the prediction model can generate predictions that indicate whether a selected utility process (e.g., reorganization or rebuilding) can be successfully completed in one or more periods of the time frame. In some implementations, the predictions of whether the selected utility process can be successfully completed may include one or more predictions that the selected utility process has a high probability of being successfully completed, has a moderate probability of being successfully completed, or has a low probability of being successfully completed if initiated at a particular time in the time frame.

Embodiments of a system for predicting successful completion of a database utility process within a time frame having concurrent user access to the database can offer several advantages. Database utility processes such as reorganization and rebuilding processes are typically used to increase performance and efficiency in a database system. If the utility processes cannot be successfully completed, then neither performance nor efficiency is increased. Instead, repeated unsuccessful attempts to run a utility process may consume valuable resources unnecessarily and become a drain on the system. Predicting a time at which a utility process may be successfully completed limits the system downtime experienced by users and minimizes the system resources needed to complete the process.

Turning to FIG. 1, a brief description of the infrastructure of communication system 100 is now provided. Elements of FIG. 1, such as database 120, database server 130, machine learning server 140, network server 170, user terminal 160, utility history repository 180, and/or user devices 105, may be coupled to one another through one or more interfaces employing any suitable connections (wired or wireless), which provide viable pathways for network communications. Additionally, any one or more of these elements of FIG. 1 may be combined or removed from the architecture based on particular implementations and/or configuration needs.

Generally, communication system 100 can be implemented in any type or topology of networks. Within the context of the disclosure, networks such as networks 110 and 115 represent a series of points or nodes of interconnected communication paths for receiving and transmitting packets of information that propagate through communication system 100. These networks offer communicative interfaces between sources, destinations, and intermediate nodes, and may include any local area network (LAN), virtual local area network (VLAN), wide area network (WAN) such as the Internet, wireless local area network (WLAN), metropolitan area network (MAN), Intranet, Extranet, virtual private network (VPN), and/or any other appropriate architecture or system that facilitates communications in a network environment or any suitable combination thereof. Networks 110 and 115 can use any suitable technologies for communication including wireless (e.g., 3G/4G/5G/nG network, WiFi, Institute of Electrical and Electronics Engineers (IEEE) Std 802.11™-2012, published Mar. 29, 2012, WiMax, IEEE Std 802.16™-2012, published Aug. 17, 2012, Radio-frequency Identification (RFID), Near Field Communication (NFC), Bluetooth™, etc.) and/or wired (e.g., Ethernet, etc.) communication. Generally, any suitable means of communication may be used such as electric, sound, light, infrared, and/or radio (e.g., WiFi, Bluetooth, NFC, etc.). Suitable interfaces and infrastructure may be provided to enable communication within the networks.

In general, “servers,” “clients,” “computing devices,” “storage devices,” “network elements,” “database systems,” “data repositories,” “network servers,” “user devices,” “user terminals,” “systems,” “databases,” “repositories,” etc. (e.g., 105, 120, 130, 140, 160, 170, 180, etc.) in example communication system 100, can include electronic computing devices operable to receive, transmit, process, store, and/or manage data and information associated with communication system 100. As used in this document, the term “computer,” “processor,” “processor device,” or “processing device,” is intended to encompass any suitable processing device. For example, elements shown as single devices within communication system 100 may be implemented using a plurality of computing devices and processors, such as server pools including multiple server computers. In some embodiments, one or more of the elements shown in FIG. 1 may be combined to form a mainframe system. Further, any, all, or some of the computing devices may be adapted to execute any operating system, including IBM zOS, Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, computing devices, storage devices, network elements, database systems, network servers, user devices, user terminals, systems, databases, repositories, etc. (e.g., 105, 120, 130, 140, 160, 170, 180, etc.) can each include one or more processors, computer-readable memory, and one or more interfaces, among other features and hardware. Servers can include any suitable software component, manager, controller, module, or computing device(s) capable of hosting and/or serving software applications and/or services, including distributed, enterprise, or cloud-based software applications, data, and services. For instance, in some implementations, database server 130, machine learning server 140, storage devices 122A-122C of database 120, utility history repository 180, and network server 170, or other sub-system of communication system 100, can be at least partially (or wholly) cloud-implemented, web-based, or distributed to remotely host, serve, or otherwise manage data, software services and applications interfacing, coordinating with, dependent on, or used by other services, devices, and users (e.g., via network user terminals, other user terminals, etc.) in communication system 100. In some instances, a server, system, subsystem, or computing device can be implemented as some combination of devices that can be hosted on a mainframe system, computing system, server, server pool, or cloud computing environment and may share computing resources, including shared memory, processors, and interfaces.

While FIG. 1 is described as containing or being associated with a plurality of elements, not all elements illustrated within communication system 100 of FIG. 1 may be utilized in each alternative implementation of the present disclosure. Additionally, one or more of the elements described in connection with the examples of FIG. 1 may be located external to communication system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

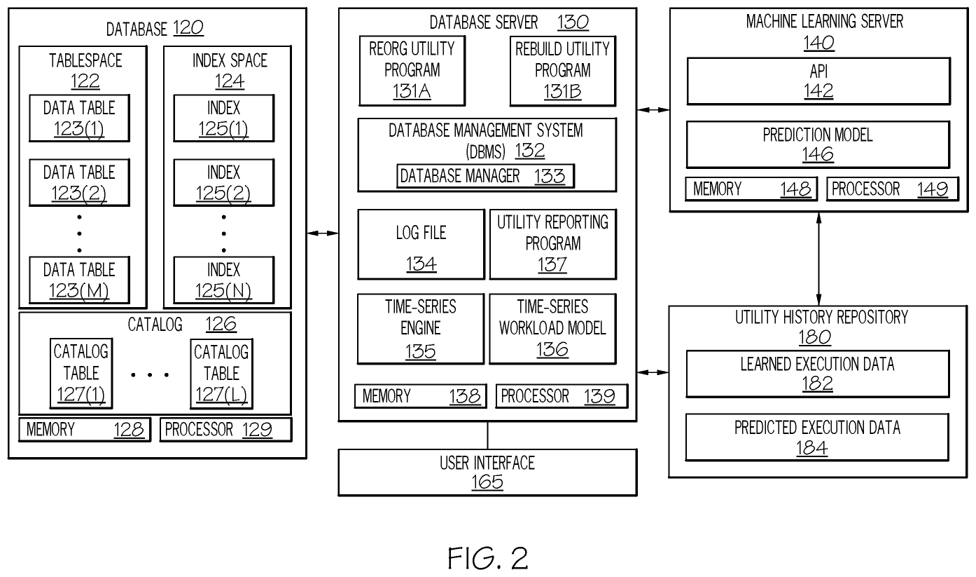

FIG. 2 is a simplified block diagram that illustrates additional possible details of certain components of communication system 100. Database 120 may include a tablespace 122, an index space 124, and a catalog 126. Tablespace 122 may include one or more data tables 123(1)-123(M). The number of data tables included in a single tablespace, such as tablespace 122, may vary at least in part based on the type of tablespace that is configured. Index space 124 may include one or more indexes 125(1)-125(N), and each index can be associated with a single data table. In some embodiments, each index space contains only one index. It should be noted that FIG. 2 is a simplified block diagram for illustrative purposes, and that a database, such as database 120, may include any number of tablespaces and indexes.

Database 120 may also include a catalog 126, with one or more catalog tables 127(1)-127(L). Catalog tables may contain information about objects (e.g., tablespace 122, data tables 123(1)-123(M), index space 124, indexes 125(1)-255(N)) in database 120 and each catalog table may be specific to a particular type of object in at least one embodiment. For example, one catalog table may be associated with data tables and each row may contain information related to a particular data table. Another catalog table may be associated with tablespaces and each row may contain information related to a particular tablespace. Yet another catalog table may be associated with indexes and each row may contain information related to a particular index. In some embodiments, a catalog table may be associated with index spaces and each row may contain information related to a particular index space. Database 120 may also include appropriate hardware, including, but not necessarily limited to a memory 128 and a processor 129.

Database server 130 may include a database management system (DBMS) 132, which creates and manages databases, including providing data utilities (e.g., batch utilities), tools, and programs. A database manager 133 can create a database processing region (also referred to as a multi-user facility (MUF)) where user processing and most utility processes flow. One or more data utilities may be run by database manager 133 to perform various functions on database 120. For example, a reorganization (reorg) utility program 131A can reorganize one or more areas of a database, such as tablespace 122, by unloading (e.g., reading) data from the one or more areas of database 120 and then loading (e.g., storing) the reorganized data into one or more areas of another database or the same database. A rebuild utility program 131B rebuilds an index space by rebuilding each index from the appropriate tablespace(s) to which the indexes correspond.

When executing, the data utility programs read all or part of the data from database 120 into memory. For example, reorg utility program 131A may read an entire tablespace into memory during the reorganization process but may not reorganize every tablespace associated with the database during the same reorganization process. Rebuild utility program 131B may read an entire index space into memory during the rebuilding process or may build new indexes in memory during the rebuilding process and replace the old indexes.

Database server 130 may also include a log file 134, a utility reporting program 137, a time-series engine 135, and a time-series workload model 136. Every database transaction, such as add, delete, update, etc., may be recorded in a log file, such as log file 134. Generally, any information needed to recover the results of program execution and the contents of the database are recorded in log file 134. Log records describe changes to the database such as changes to control information, changes to database pointers, and changes to data itself. A log record to undo or redo a change may be recorded for every change to the database. In addition, log records may be recorded for data row insertions and database exceptions. Log records, therefore, indicate which data rows have been added, deleted, or updated, and may be recorded in the sequence in which the changes are made.

Time-series engine 135 may be provided in database server 130, or in another device such as machine learning server 140, from which log file 134 can be accessed. In at least one embodiment, time-series engine 135 is configured to use time-series data from log file 134 to train one or more predictive time-series models, such as time-series workload model 136. Predictive time-series models created by time-series engine 135 may use any modeling techniques to generate predicted workloads of a particular object such as a tablespace or index space at a future time or during a future time frame. The term ‘workload’ generally refers to the amount of processing by a computing system at a particular time or during a particular time period. Workload may be measured, for example, based on the number of transactions logged in the log file per some unit of time (e.g., transactions/second). In other examples, workload may be measured based on response time. Workload may be determined for particular objects or for a database as a whole.

In at least one embodiment, time-series engine 135 may access log file 134 and potentially archives of log file 134 to extract multiple sets of time series data reflecting workloads at various times of the day, days of the week, weeks of the month, months of the year, etc. Time-series workload model 136 can be trained based on the multiple sets of time-series data specific to a particular object. Thus, the time-series data from the log file for a particular object is used as training data for a predictive time-series model to establish standard or expected workloads on the particular object for a given time frame during a particular day of the week, for example, and to predict workloads of the object during the given time frame on the same day of the week in the future. The predictive time-series models could be trained to predict workloads based on any time frames of a particular day of the week (e.g., Saturday or Sunday), a particular day of the month (e.g., first day or last day), a particular day of the year (e.g., federal holidays), etc. In particular, a predictive time-series model of an object may be trained to predict workloads on the object during quiet times of the database (e.g., 12 am-4 am on Sundays).

Utility reporting program 137 can be provisioned in database server 130 or in another device such as machine learning server 140, from which utility history repository 180 can be accessed and updated. Utility reporting program 137 can be run in a series of processes against each object for which it is desirable to obtain predictions related to whether a database utility process will succeed or fail. The utility reporting program can learn the parameters of a particular utility program for a particular object of the database. For example, utility reporting program 137 can be run against tablespace 122 to learn information related to partially simulated executions of reorg utility program 131A. Utility reporting program 137 may be run against index space 124 to learn information related to partially simulated executions of rebuild utility program 131B. Information learned by utility reporting program 137 can include, but is not necessarily limited to, parameters related to the workload at various stages of a particular utility process that may be executed for a particular object. Specifically, workload parameters may include the workload measured at a simulated beginning stage of the utility process, the workload measured at a simulated end stage of the utility process, and the workload measured at a monitored middle stage of the utility process. The information may also include the size of the object, an identifier of the object, an indication as to whether each stage executed successfully and/or an indication as to whether the utility process was successfully completed. In some implementations, an amount of time may be determined for the simulated beginning stage and the simulated end stage and potentially may be calculated for the monitored middle stage.

The information obtained for the beginning stage of a utility process may be obtained by simulating the operation of the beginning stage. For example, the beginning stage may attempt to quiesce the object, which includes stopping the object activity (e.g., taking the object off-line) for a very short time and then starting the object activity again (e.g., putting the object back on-line). Utility reporting program 137 may attempt to put the object back on-line after the all object activity has stopped and after the object has been copied to a shadow object if a shadow object is needed by the utility process. Accordingly, the workload on the object during this beginning stage may be determined (e.g., by evaluating log records just prior to stopping the object activity). Also, a determination may be made as to whether the operation to take the object off-line contemporaneously with the determined workload was successful. The learned information may be stored in utility history repository 180 in learned execution data 182.

Information related to the end stage of the utility process may be obtained by simulating the operation of the end stage. For example, the end stage may attempt to quiesce the object, which includes stopping the object activity (e.g., taking the object off-line) for a very short time and then starting the object activity again (e.g., putting the object back on-line). Utility reporting program 137 may attempt to put the object back on-line after all object activity has stopped and after the original object is replaced with the shadow object that has been created (e.g., reorganized or rebuilt) by the utility process. Accordingly, the workload on the object during this end stage may be determined (e.g., by evaluating log records just prior to stopping the object activity). Also, a determination may be made as to whether the operation to take the object off-line contemporaneously with the determined workload was successful. The learned information may be stored in utility history repository 180 in learned execution data 182.

Information related to the middle stage of the utility process on an object may be obtained by estimating the expected run time of the middle stage and then monitoring the log records for the object for the duration of the estimated run time. For example, if the run time is estimated at one hour, then after the completion of the simulated first stage of the utility process (e.g., after the quiesce is finished), log records for the object that span one hour can be monitored to calculate the level of system activity (or workload) on the object for the duration of the estimated run time. A determination can be made, based on the calculated workload during the middle stage, whether the utility process could adequately update the shadow object based on the log records being recorded during the estimated run time of the middle stage. For example, if the activity level is very high, then log records may be written to the log file at a rate that the utility process cannot match with updates to the shadow object. Thus, the number of outstanding log records (log records containing updates that have not been made to the shadow object) may continue to grow even as the utility process continues to update the shadow object with the outstanding log records.

A threshold may be used to determine that the system activity level is too high to allow the utility process to perform a sufficient number of updates to the shadow object based on the log records written to the log file (e.g., number of log records indicating updates to the object is greater than the threshold) during the estimated run time for the middle stage of the utility process. Conversely, the threshold may be used to determine that the system activity level is low enough to allow the utility process to perform a sufficient number of updates to the shadow object based on the log records written to the log file (e.g., number of log records indicating updates to the object is less than the threshold) the calculated time for the second stage of the utility process.

Database server 130 may also include hardware including, but not limited to, a memory 138 and a processor 139. In some implementations, a user interface 165 may also be coupled to database server 130. User interface could include any suitable hardware (e.g., display screen, input devices such as a keyboard, mouse, trackball, touch, etc.) and corresponding software to enable an authorized user (e.g., Database Administrator (DBA)) to communicate directly with database server 130.

Machine learning server 140 can include components such as an application programming interface (API) 142 and a prediction model 146. Machine learning server 140 can also include appropriate hardware including, but not limited to, a memory 148 and a processor 149. API 142 may be used by prediction model 146 to access time-series workload model 136, log file 134, and/or utility history repository 180. In some implementations, prediction model 146 may be provisioned on database server 130.

Prediction model 146 can be implemented as an algorithm to predict whether a database utility program that is executed for a particular object during a given time frame can be successfully completed. In at least one embodiment, an identifier of the database utility program (e.g., reorg utility program 131A, rebuild utility program 131B), an identifier of the object (e.g., tablespace 122, index space 124), and the desired time frame (e.g., 12 am-4 am on Sunday morning, etc.) may be provided to prediction model 146 as input by, for example, a user such as a database administrator (DBA) or another authorized user. To generate predictions, prediction model 146 may correlate predicted workloads for the specified object during the desired time frame and learned execution data 182 indicating the successes and failures of utility process executions on the specified object.

More specifically, prediction model 146 may provide the identifier of the object and desired time frame to time-series workload model 136, which can predict workloads on the object over the time frame. In at least one embodiment, this information can be generated in the form of a graph of predicted workloads on the object by the time frame. Prediction model 146 can also search learned execution data 182 in utility history repository 180 for learned execution data corresponding to the specified object. Information from utility history repository 180 can reveal the parameters derived from workloads running on the object that have been determined to be less than a workload threshold for the database utility process to execute to completion on the object, and other parameters derived from workloads running on the object that have been determined to be greater than a workload threshold for the database utility process to execute to completion. These workload parameters can be revealed for each stage of a database utility process and used to find a “sweet spot” in the graph of workload predictions over the desired time frame where the database utility process can be executed to completion.

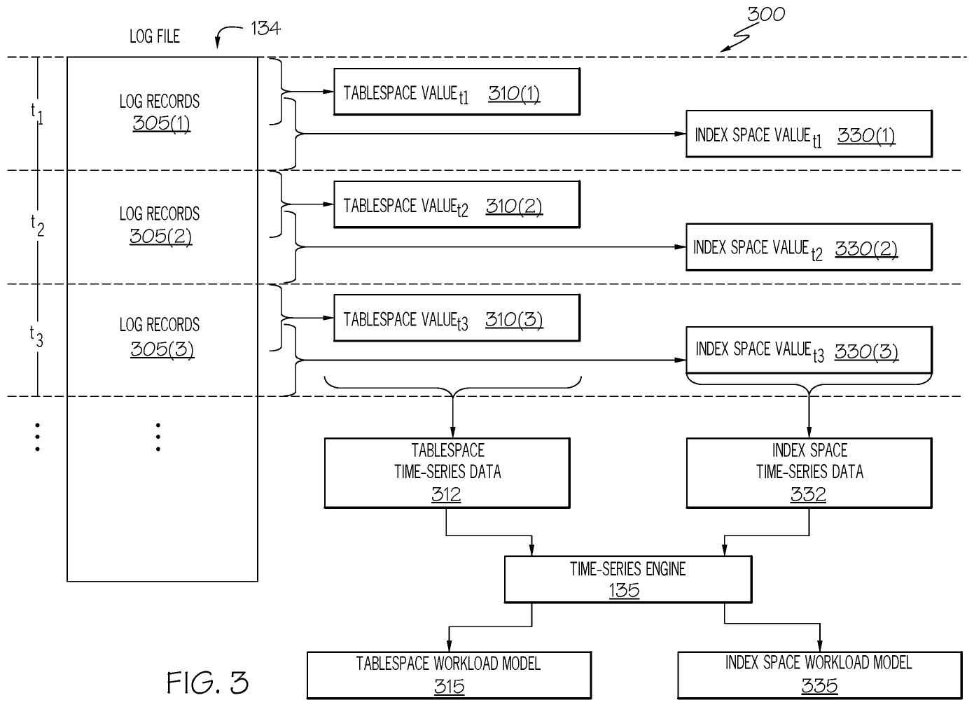

Turning to FIG. 3, FIG. 3 is a block diagram of an example time-series data extraction 300 according to one or more embodiments of communication system 100 described herein. Data extraction 300 illustrates a possible data extraction from log file 134 that is performed by time-series engine 135 of database server 130. Time-series engine 135 extracts time-series data from log file 134, which contains log records of transactions (e.g., add, delete, update, move, etc.) performed on objects (e.g., tablespaces, index spaces) in a database, such as database 120. The extracted time-series data can identify workloads on an object in a database, which can be used to generate time-series models that can make predictions related to workloads on the object in a future time frame. In this example, time-series engine 135 extracts tablespace time-series data 312 associated with a tablespace such as tablespace 122, and also extracts index space time-series data 332 associated with an index space such as index space 124.

Time-series engine 135 may search and/or parse log file 134 to identify, calculate, or otherwise obtain time-series data based on transactions that are recorded for a particular object (e.g., tablespace 122 or index space 124). The log file may contain log records 305(1)-305(3) of transactions for multiple objects over multiple time periods. The time periods may be defined using any suitable time measurement (e.g., one-second periods, half-second periods, 2-second periods, etc.). For illustration purposes, assume time-series engine 135 extracts data from log records 305(1)-305(3) for transactions performed during one-second time periods. Thus, the duration of each time period is one-second. Assume transactions are recorded in log file 134 beginning Saturday, November 10 at 24:00:00.00. In this scenario, time period t1 refers to the period of time on Saturday, November 10 from 24:00:00.00 to 24:00:00.99, time period t2 refers to the period of time on Saturday, November 10 from 24:00:01.00 to 24:00:01.99, and time period t3 refers to the period of time on Saturday, November 10 from 24:00:02.00 to 24:00:02.99.

In this example, log records 305(1) may contain multiple log records for transactions performed during the one-second time period t1 on tablespace 122 and on index space 124. Log records 305(2) may contain multiple log records for transactions performed during the one-second time period t2 on tablespace 122 and on index space 124. Log records 305(3) may contain multiple log records for transactions performed during the one-second time period t3 on tablespace 122 and on index space 124. Furthermore, as previously described herein, log file 134 is not limited to log records of a single tablespace and single index space. Rather, log records may reflect transactions on any or all objects in database 120, which could include multiple tablespaces and/or index spaces.

For each time period, time-series engine 135 may calculate or otherwise determine a value representing the workload of a selected object during that time period. In this example scenario, where the log file contains log records of transactions for tablespace 122, tablespace valueₜ₁ 310(1) represents the workload on tablespace 122 during time period t₁, tablespace valueₜ₂ 310(2) represents the workload on tablespace 122 during time period t₂, and tablespace valueₜ₃ 310(3) represents the workload on tablespace 122 during time period t₃. In this example, the log file may also contain log records of transactions for index space 124. Accordingly, index space valueₜ₁ 330(1) represents the workload on index space 124 during time period t₁, index space valueₜ₂ 330(2) represents the workload on index space 124 during time period t₂, and index space valueₜ₃ 330(3) represents the workload on index space 124 during time period t₃.

In at least one embodiment, the workload value for an object during a time period may be computed by calculating the total number of transactions recorded for the object during the time period. Accordingly, if log file contained one-hundred log records for transactions on tablespace 122 and twenty log records for transactions on index space 124 during the time period t₂, then tablespace valueₜ₂ 310(2) equals 100/second and index space valueₜ₂ 330(2) equals 20/second.

Time-series engine 135 may use the extracted tablespace time-series data 312 to train a predictive time-series model, shown as tablespace workload model 315. Similarly, time-series engine 135 may use the extracted index space time-series data 332 to train a predictive time-series model, shown as index space workload model 335. Tablespace workload model 315 and index space workload model 335 may process their respective time-series data using any machine learning techniques, predictive algorithms, or modeling techniques to learn to generate predicted workloads for tablespace 122 and index space 124, respectively, within a time frame in the future. Examples of possible predictive time-series models that could be used to implement time-series workload models (e.g., 315, 335) include AutoRegressive Integrated Moving Average (ARIMA) models or other regression models, neural networks, sequence-to-sequence models, etc.

ARIMA is a class of statistical models used for analyzing and forecasting time series data. An ARIMA model can help predict future points in the series, which is also referred to as ‘forecasting.’ An ARIMA model can have three main features, with three input parameters (i.e., p, d, and q) corresponding to the features. Parameter p is the number of lags (or prior values) included in the autoregressive model. The second feature is a regression error that is a linear combination of certain data to eliminate the non-stationarity of the data. Parameter d refers to the degree of differencing and is the number of times the data have had past values subtracted. A third feature involves replacing data values with the difference between those values and prior values, which may occur multiple times. Parameter q refers to this moving average window.

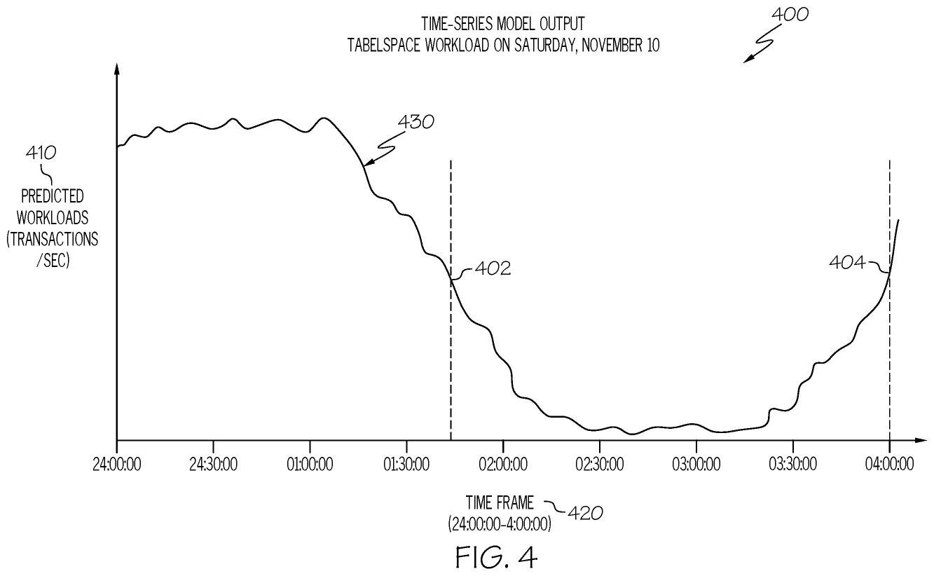

FIG. 4 is graph 400 that illustrates example output from a time-series workload model (e.g., 136) such as tablespace workload model 315 or index space workload model 335, which may be implemented using an ARIMA model. The graph shows plotting the values of predicted workloads 410 (y-axis) on an object against time in a particular time frame (x-axis) 420. The example time frame is 24:00:00 through 04:00:00 on a Saturday in the future (e.g., Saturday, November 10). In this example, the object is a tablespace, such as tablespace 122.

As seen in graph 400, plot 430 shows a very high workload for tablespace 122 between 12 am and 1 am. The workload then begins to fall at approximately 1:15 am until it reaches its lowest level at around 2:40 am. The workload then begins to sharply increase again around 3:30 am and continues increasing until the end of the time frame at 4 am. Points 402 and 404 are marked on plot 430 to indicate the workload threshold above which a particular database utility process does not typically complete successfully, and below which the particular database utility process does typically complete successfully. Points 402 and 404 may not be known by the time-series model, but prediction model 146 can use the output of a time-series model, such as the workload predictions shown in FIG. 4, to determine a “sweet spot” in the time frame 420 where the database utility program (e.g., 131A or 131B) can be executed such that the instantiated utility process is successfully completed (e.g., finishes execution without ending abnormally). In the example of FIG. 4, a database utility process may be successfully completed if the process runs between 1:45 am and 4:00 am.

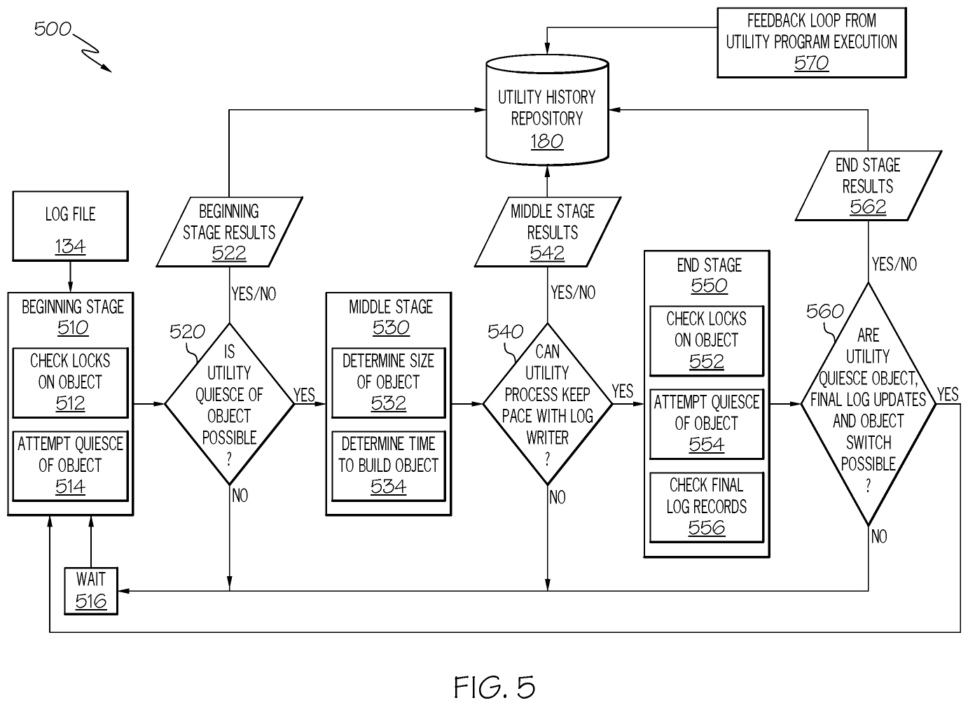

Turning to FIG. 5, FIG. 5 is a block diagram illustrating an example flow 500 for learning workload parameters and other information related to database utility program executions in communication system 100 according to at least one embodiment. Flow 500 shows the process of building utility history repository 180 with the learned information. Flow 500 may be applicable to the database utility programs that target various objects in a database (e.g., 120) including, but not necessarily limited to, reorg utility program 131A for reorganizing a tablespace (e.g., 122) or rebuild utility program 131B for rebuilding an index space (e.g., 124). In at least one embodiment, operations of flow 500 may be performed by one or more instructions associated with utility reporting program 137 of database server 130. When learning the workload parameters and other information of a particular database utility program, utility reporting program 137 may simulate certain operations of the particular database utility program and may monitor the object targeted by the particular database utility program. This learning can be performed in real-time during a quiet window of the particular database system (e.g., 12 am-2 am on Sunday morning, etc.) in order to obtain relevant workload parameters and other information. It should be noted that, although learning could be performed during any desired period of time, in practice, a quiet window for a database system typically coincides with whatever period of time is designated by a DBA to perform maintenance on the system.

Initially, learned information may be generated for a beginning stage 510 of a utility process is. At 512, the object is checked in real-time (e.g., during a quiet period of the database system) to determine whether it has been locked by a long-running thread. If the object has been locked, then the utility process will not execute successfully. If no long-running threads have locked the object, then at 514, utility reporting program 137 may simulate the utility process by attempting to quiesce the object (e.g., temporarily stop and then restart the object). The current workload on the object may be calculated based on the number of log records being written to the log file per some amount of time, such as per second. If the workload on the object is too high, then the attempt to temporarily stop the database may fail and a utility quiesce of the object is not possible.

At 520, it is determined whether a utility process quiesce of the object is possible. A quiesce is needed to create a shadow copy of the object, and to establish a start time for the utility process that can be used to identify a point in the log file after which the log records will be used to update the shadow copy of the object while the utility process is running. If a long-running thread has locked the object, or if an attempt to quiesce the database fails, then a utility process quiesce of the object at the beginning stage is not possible and the executing utility reporting program may wait at 516 for a selected process iteration time before attempting another iteration of learning. If the attempt to quiesce the database succeeds, then a determination is made that, given the current workload of the object, the beginning stage of the utility process could be successfully executed. Utility history repository 180 can be updated at 522 with beginning stage results, which include information learned from the iteration of the beginning stage of the utility process. For example, the learned information can include the workload of the beginning stage and the determination of whether the beginning stage can be successfully executed given the workload.

If the attempt to quiesce the object at 514 succeeds, then a utility quiesce of the object is possible as determined at 520. In this scenario, learned information may be generated for a middle stage 530 of the utility process. At 532, the size of the object is determined. The size of the object can be obtained, for example, from a catalog table that that describes the attributes and characteristics of a tablespace or index space. At 534, the amount of time expected to be used to build the object (e.g., reorganize the tablespace or rebuild an index space) is estimated. This estimate can be made by searching utility history repository 180 for similarly sized objects and determining the amount of time that was taken to build each of the similarly sized objects when the same utility program was executed to run against the similarly sized objects. It should be noted that the search may target utility program executions that were performed during a quiet window of the system. Thus, the amount of time that was taken to build a similarly sized object should be more relevant to how much time would be needed to build the object during the quiet window. The identified times from the utility history repository search can be averaged to estimate the amount of time expected to be used by the utility process to build the object. The time used to run a database utility program can vary greatly depending, at least in part, on the size of the object. For example, if an object contains billions of rows, the middle stage of the utility process may need 1-2 hours to run.

At 540, a determination is made as to whether the utility process can keep pace with the log writer. That is, if the rate of log records being written to the log file exceeds the rate that the utility process is capable of updating the shadow object, then a determination is made that the utility process would not keep pace with the log writer and the utility reporting program 137 may wait at 516 for a selected process iteration time before attempting another iteration of learning. If the rate of log records being written to the log file does not exceed the rate at which the utility process could be capable of updating the shadow object, then a determination is made that the utility process could keep pace with the log writer and therefore, given the current workload of the object during the middle stage, the middle stage could be successfully executed. In one example, workload may be determined based on a log start point and a log end point in time recorded in utility history repository 180. The amount of time between the log start and end points represents a selected time in which a log iteration (e.g., updating log records in the log file) can be completed. In at least one implementation, the selected time may be defined by a service level agreement (SLA). For example, if the selected time is 30 seconds, the log records may be read until a log iteration completes in 30 seconds. The workload could be determined based on the log records written (and read) during this selected time. For utility processes where the estimated time to build the object is lengthy, multiple workloads may be calculated for the middle stage. This rate may be compared to a threshold rate to determine whether the utility process would keep pace with the log writer. Utility history repository 180 can be updated at 532 with middle stage results, which include information learned from the iteration of the middle stage of the utility process. For example, the learned information can include the workload of the middle stage and the determination of whether the middle stage can be successfully executed given the workload.

If it is determined that the utility process can keep pace with the log writer, then learned information may be generated for an end stage 550 of the utility process. At 552, the object is checked to determine whether it has been locked by a long-running thread. If the object has been locked, then the end stage of the utility process will not execute successfully. If no long-running threads have locked the object, then at 554, utility reporting program 137 may simulate the utility process by attempting to quiesce the object. The current workload on the object may be calculated based on the number of log records being written to the log file per some amount of time, such as per second. If the workload on the object is too high, then the attempt to temporarily stop the database may fail and a utility quiesce of the object is not possible.

A quiesce of the object is needed to perform the final log record updates to the shadow copy of the object, and to replace the live object with the shadow copy of the object. Updates indicated in a last batch of log records may not be performed on the shadow copy of the object during the middle stage of the utility process if the updates are performed in time iterations (e.g., 10-minute iterations). Accordingly, if the attempt to temporarily stop the database at 554 succeeds, then a check may be performed at 556 to determine whether the updates indicated in the final batch of log records (e.g., log records written during the last 10-minutes before the object was stopped) are possible within a specified time threshold. In some embodiments, a time threshold may be specified to limit the amount of time allowed for processing the updates in the final batch of log records. If the shadow object is not updated with all of the updates in the final batch of log records within the time threshold, then the end stage would not execute successfully, and the utility process could fail.

At 560, it is determined whether a utility process quiesce of the object is possible, whether updating the shadow object from the final batch of log records within the time threshold is possible, and a switch between the shadow object and the live object is possible. If a long running thread has locked the object or the attempt to quiesce the object fails, then a utility process quiesce of the object is not possible at the end stage and the executing utility reporting program may wait at 516 for a selected process iteration time before attempting another iteration of learning. If the attempt to quiesce the database succeeds, updates from the final batch of log records can be completed within the time threshold, and a switch between the shadow object and the live object is possible, then a determination is made that, given the current workload of the object, the end stage of the utility process could be successfully executed. Utility history repository 180 can be updated at 562 with end stage results, which include information learned from the iteration of the end stage of the utility process. For example, the learned information can include the workload at the end stage and the determination of whether the end stage can be successfully executed given the workload.

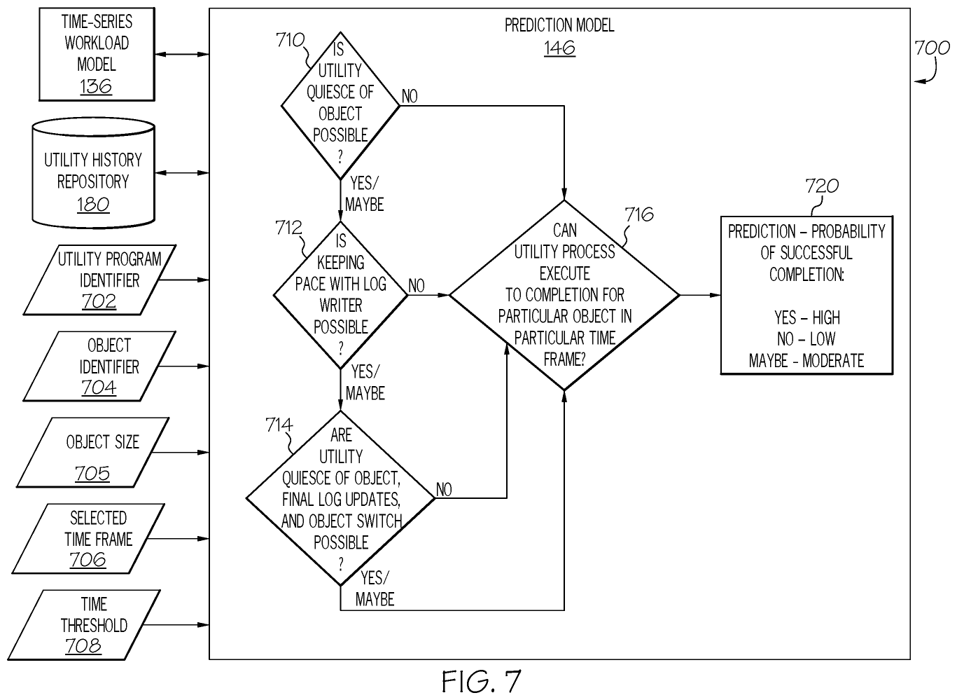

Also, at 570, a feedback loop is provided to utility history repository 180. If the utility program is executed in response to predictions made by prediction model 146 (as further described here with reference to FIGS. 7-9), then a feedback loop 570 can store information related to the actual execution in the utility history repository. In particular, an indication of whether the utility program successfully completed its execution at a particular time may be stored and mapped to the prediction of whether the utility program would be able to complete the execution.

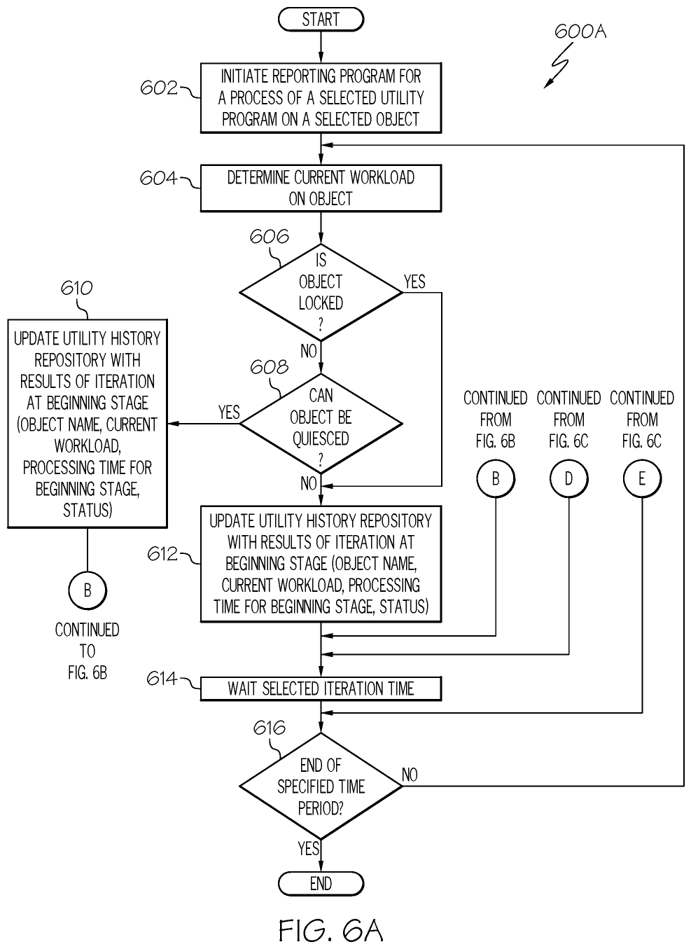

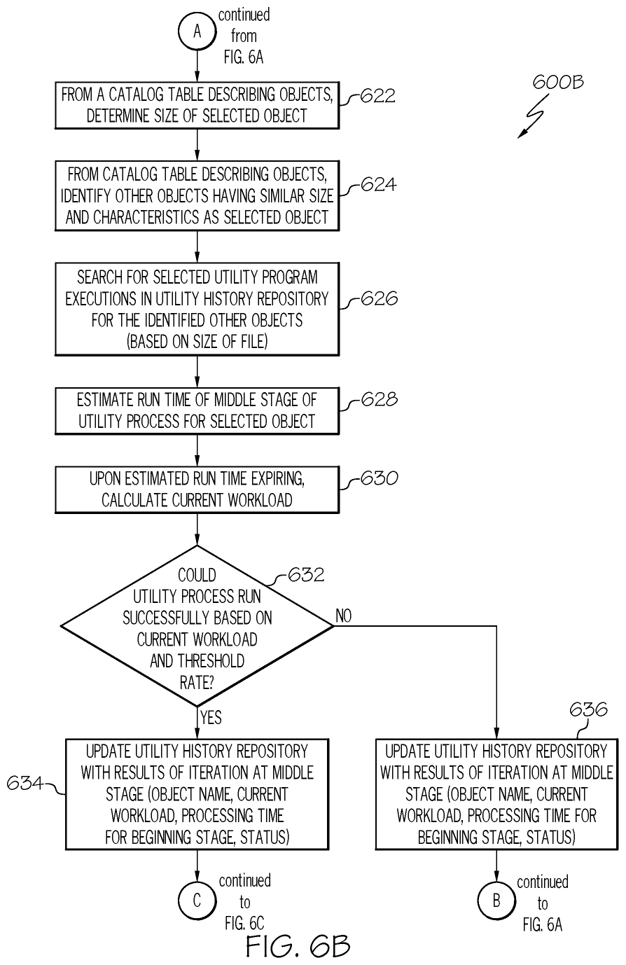

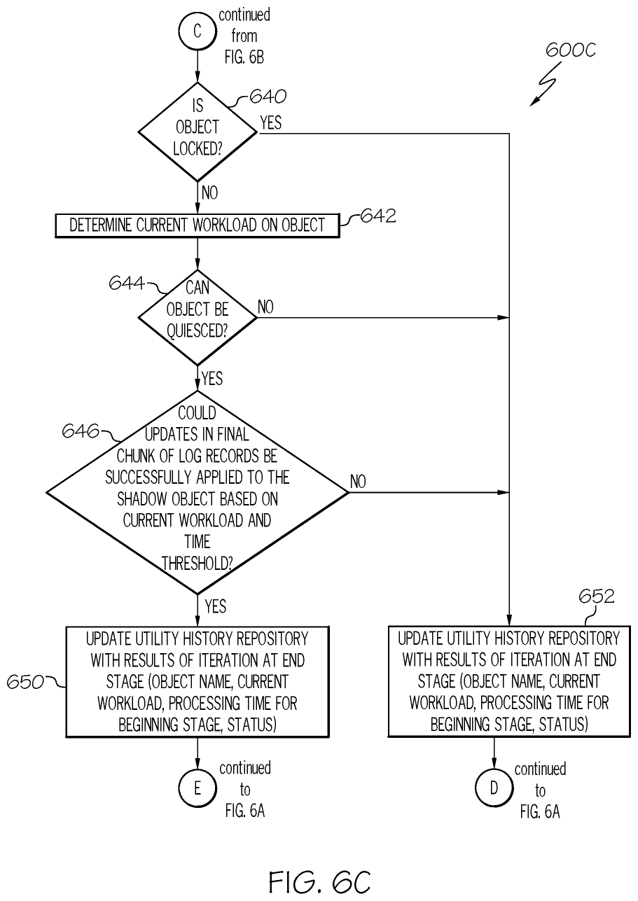

FIGS. 6A, 6B, and 6C show flowcharts 600A, 600B, and 600C, respectively, which illustrate example techniques related to one or more embodiments of a communication system, such as communication system 100. In at least one embodiment, one or more sets of operations correspond to the activities of FIGS. 6A-6C for learning workload parameters and other information of database utility processes that are instantiated by executing database utility programs (e.g., reorg utility program 131A, rebuild utility program 131B). In one example, a database server (e.g., 130), or a portion thereof, may perform at least some of the operations in the one or more sets of operations. The database server may comprise means, such as processor 139 and memory 138, for performing the operations. In an embodiment, one or more operations of flowcharts 600A, 600B, and 600C may be performed by a utility reporting program (e.g., 137).

Flowchart 600A generally shows a flow for generating learned information for a beginning stage of a database utility process. At 602, the utility reporting program is initiated to generate learned information of a process of a selected utility program (e.g., reorg utility program 131A or rebuild utility program 131B) for a selected object (e.g., tablespace 122 or index space 124). For example, if a database has multiple tablespaces, then each execution of the utility reporting program could generate learned information for the reorg utility program for a different tablespace.

At 604, the current real-time workload on the object can be calculated. For example, the number of updates currently being performed on the object may be determined by accessing a log file (e.g., 134) of the database. The number of log records that indicate an update to the object may be determined per second in one embodiment.

At 606, a determination is made as to whether the object is locked. The object may be locked if a long-running thread is executing against the object. If the object is not locked, then at 608, a determination is made as to whether the object can be quiesced. In at least one embodiment, this determination can be made by simulating the beginning stage of the utility process and attempting to quiesce (e.g., temporarily stopping and then starting) the object of the database.

If the object cannot be quiesced, or if the object was determined to be locked at 606, then at 612, the utility history repository (e.g., 180) can be updated with the results of the iteration at the beginning stage. For example, the results may include, but are not necessarily limited to, the amount of time for executing the beginning stage of the utility process, the current workload calculated for the beginning stage, the name of the object, and an indication that the execution of the beginning stage would not be successful under the current workload.

Once the determination is made that the beginning stage would not be able to execute successfully, the utility reporting program may wait at 614 for a selected process iteration time before beginning another iteration of learning for the selected utility program and the selected object. Once the selected process iteration time has passed, at 616, a determination may be made as to whether a specified period of time for learning has expired. If so, then the utility reporting program may end. Otherwise, flow may resume at 604, where a new current workload on the object is determined. In at least one scenario, the specified period of time for learning may be a quiet window for the system.

If the attempt to quiesce the object is successful, then at 608, a determination is made that the object could be quiesced under the current workload, and at 610, the utility history repository (e.g., 180) can be updated with the results of the iteration at the beginning stage. For example, the results may include, but are not necessarily limited to, the amount of time for executing the beginning stage of the utility process, the current workload calculated for the beginning stage, the name of the object, and an indication that the execution of the beginning stage could be successful under the current workload.

If the beginning stage could be successful under the current workload, then flow passes to FIG. 6B. At 622, the size of the object against which the utility process would run, is determined. In at least one embodiment, the size of the object may be determined from a catalog table (e.g., 127(1)-127(L)) that describes the attributes and specifications of objects in the database. In one embodiment, the utility history repository may be searched to determine the size of the object the last time the utility process was executed for the object. If the size is the same or within an acceptable threshold, then an estimated run time to build the object can be set to the actual run time to build the object the last time the utility process was executed for the object. If there were multiple executions of the utility process for the object, then the actual run times to build the object can be averaged.

If there is no information related to a previous execution of the utility process for the object, or if the previous executions were performed when the object's size was not within the acceptable threshold to the current size of the object, then at 624, other objects having similar sizes and characteristics as the selected object may be identified. These other objects may be identified by searching the catalog table (e.g., 127(1)-127(L)) that describes the attributes and specifications of objects in the database.

At 626, utility history repository 180 may be searched to identify executions of the selected utility program for the identified other objects. For each identified execution, the utility history repository may contain information that indicates the amount of time that the process instantiated by the selected database utility program used to perform the desired function (e.g., reorganization, rebuilding) on that identified other object. In some embodiments, the amount of time may correspond to only the middle stage of the utility process.

At 628, the run time for the middle stage of the utility process on the selected object is estimated. In at least one embodiment, this run time may be estimated by calculating an average running time of the middle stage of the identified executions of the selected utility program may be calculated. This calculation may be used as an estimate for how long the middle stage of the utility process running against the selected object should take.

At 630, upon the expiration of the estimated run time, the current workload can be calculated. In at least one embodiment, the current workload could be calculated based on the estimated run time and the total number of log records indicating updates to the object that are added to the log file during the estimated run time, and which are not in the final iteration of log records to be applied to the shadow object (e.g., log records indicating updates to object per second).

At 632, a determination may be made as to whether the middle stage of the utility process could run successfully based on the current workload and a threshold rate. In at least one example, this determination may be made by comparing the current workload to a threshold rate to determine whether the middle stage of the utility process can keep pace with log writer and therefore, execute successfully. The current workload in the middle stage may be calculated as previously described herein.

If the current workload is greater than the threshold rate, then the middle stage of the utility process would not be able to keep pace with the log writer and therefore, a determination is made that the middle stage of the utility process could not execute successfully under the current workload. Flow passes to 636, and the utility history repository (e.g., 180) can be updated with the results of the iteration in the middle stage. For example, the results may include, but are not necessarily limited to, the estimated time for executing the middle stage of the utility process, the current workload calculated for the middle stage, the name of the object, and an indication that the execution of the middle stage would not be successful under the current workload. Flow may then pass back to flowchart 600A, where the utility reporting program may wait at 614 for a selected process iteration time before beginning another iteration of learning for the selected utility program and the selected object, as previously described herein.

If the current workload is less than the threshold rate, then the middle stage of the utility process should be able to keep pace with the log writer and therefore, a determination is made that the middle stage of the utility process could execute successfully under the current workload. Flow passes to 634, and the utility history repository (e.g., 180) can be updated with the results of the iteration in the middle stage. For example, the results may include, but are not necessarily limited to, the estimated time for executing the middle stage of the utility process, the current workload calculated for the middle stage, the name of the object, and an indication that the execution of the middle stage could be successful under the current workload.

If the middle stage is determined to be capable of successful execution under the current workload, then flow passes to FIG. 6C, where learned information is generated for the end stage of the utility process. At 640, the selected object is checked to determine whether it has been locked by a long-running thread. If the object has been locked, then the end stage of the utility process would not execute successfully.

If no long-running threads have locked the object, then at 642, the current workload on the object may be calculated based on the number of log records being written to the log file per some amount of time, such as per second.

At 644, utility reporting program 137 may simulate the utility process by attempting to quiesce the object. If the current workload on the object is too high, then the attempt to temporarily stop the database may fail and a utility quiesce of the object is not possible.

If the attempt to quiesce the object at 644 succeeds, then a check may be performed at 646 to determine whether the updates indicated in the final batch of log records (e.g., log records written during the last 10-minutes before the object was stopped) are possible within a specified time threshold given the current workload. In some embodiments, a time threshold may be specified to limit the amount of time allowed for applying updates to a shadow object from a final batch of log records. If a shadow object could not be updated with all of the updates in the final batch of log records within the time threshold, then the end stage would not execute successfully, and the utility process would fail.

If a determination is made, at 646, that updates could be applied to a shadow object from the final batch of log records within the time threshold and given the current workload, then a determination is made that the end stage of the utility process could be successfully executed for the selected object under the current workload. Flow passes to 650, and the utility history repository (e.g., 180) can be updated with the results of the iteration in the end stage. For example, the results may include, but are not necessarily limited to, the amount of time for executing the end stage of the utility process, the current workload calculated for the end stage, the name of the object, and an indication that the execution of the end stage could be successful under the current workload. Flow may then pass back to flowchart 600A, where a determination may be made as to whether the specified period for running the database utility process has expired. If so, then the utility reporting program may end. Otherwise, flow may resume at 604, to begin another iteration of learning for the selected utility program and the selected object, as previously described herein.

If a determination is made, at 646, that updates could not be applied to a shadow object from the final batch of log records within the time threshold and given the current workload, that the object could not be stopped based on the current workload (at 642), or that the object is locked due to a long-running thread (at 640), a determination is made that the end stage of the utility process would not be successfully executed for the selected object under the current workload. Thus, the utility process would not be successfully completed. Flow passes to 652, and the utility history repository (e.g., 180) can be updated with the results of the iteration in the end stage. For example, the results may include, but are not necessarily limited to, the amount of time for executing the end stage of the utility process, the current workload calculated for the end stage, the name of the object, and an indication that the execution of the end stage would not be successful under the current workload. Flow may then pass back to flowchart 600A, where the utility reporting program may wait at 614 for a selected process iteration time before beginning another iteration of learning for the selected utility program and the selected object, as previously described herein.

Turning to FIG. 7, FIG. 7 is a block diagram illustrating an example flow 700 in communication system 100 for predicting the likelihood of a database utility process executing to completion according to at least one embodiment. Flow 700 shows the process of applying information learned by a time-series workload model (e.g., 136) and a utility reporting program (e.g., 137) to evaluate a selected time frame to determine whether a selected database utility program can be executed for a selected object and successfully completed at some point in time within the selected time frame. Flow 700 may be applicable to the executions of database utility programs that target various objects in a database (e.g., 120) including, but not necessarily limited to, reorg utility program 131A for reorganizing a tablespace (e.g., 122) or rebuild utility program 131B for rebuilding an index space (e.g., 124). In at least one embodiment, operations of flow 700 may be performed by one or more instructions associated with prediction model 146 of machine learning server 140.

Prediction model 146 may be initiated to predict the likelihood that a selected database utility program (e.g., 131A or 131B) can, during a selected time frame, be executed for a selected object and successfully complete the execution. Accordingly, in at least some embodiments, certain inputs may be provided to prediction model 146, either manually by a user, for example, or in an automated process. Inputs may include a database utility program identifier 702 of the utility program (e.g., reorg utility program 131A or rebuild utility program 131B) for which predictions are to be made by the prediction model. Inputs may also include an object identifier 704 of the object selected to be processed by the database utility process. The inputs may also include the object size 705. In other embodiments, prediction model 146 may determine the object size using the object identifier 704 and the catalog table that describes the attributes and characteristics of objects in the database. Other inputs may include a selected time frame 706 on which the prediction model 146 bases its predictions. The time frame is the selected period of time in the future for which workload predictions are made. A further input can include a time threshold 708, which specifies the amount of time the object can be stopped (e.g., in read-only mode).

Initially, prediction model 146 may access time-series workload model 136 to obtain predictions for workloads on the object. In at least one embodiment, a time-series workload model is specific to an object. If multiple time-series workload models have been trained for respective objects in the database (e.g., tablespace workload model 315, index space workload model 335), then the object identifier 704 can be used to access the appropriate time-series workload model. For illustration purposes, with reference to the description of FIG. 7, time-series workload model 136 is assumed to be trained for the object associated with object identifier 704.

The selected time frame 706 can be provided to time-series workload model 136. The time-series workload model can generate predictions of workloads for the selected object during the selected time frame 706. In at least one embodiment, the workload predictions may be plotted on a graph of object workload against time, as shown in FIG. 3.

Generally, prediction model 146 can select a beginning start time in the time frame and use learned information from utility history repository 180 to determine whether a particular utility program can be initiated at the selected beginning start time and successfully completed. This determination is based on the workload prediction at the selected beginning start time and the workload predictions subsequent to the selected beginning start time that are expected to occur while the utility process is running. The learned information obtained from utility history repository 180 indicates whether a utility process (and its particular stages) can be successfully completed or not when running contemporaneously with certain workloads on the object.

In more specific terms, prediction model 146 can identify a first predicted workload of the object at a selected beginning start time in the time-series workload predictions (e.g., on the graph). Based on the first predicted workload of the object, prediction model 146 can search utility history repository 180 for calculated workloads on the object that are associated with previously learned information related to the beginning stage of the utility process. In addition, calculated workloads on the object that are associated with actual executions of the beginning stage of the utility process may also be searched, if such information is available (e.g., 570). A determination can be made at 710 as to whether a utility quiesce of the object is possible at the selected beginning start time. This determination may be based on the calculated workloads on the object and the indications of whether the beginning stage of the utility process could be successfully executed or not successfully executed contemporaneously with those calculated workloads.

In one scenario, assume a utility program execution entry for the object was found in the utility history repository and the calculated workload at the beginning stage of the utility process equaled the first predicted workload of the object at the selected beginning start time (e.g., on the graph). If the utility program execution entry for the object indicates that the beginning stage could be successfully executed, then at 710, a determination can be made that utility quiesce of the object is possible such that the beginning stage of the utility process would likely be successfully executed if initiated at the selected beginning start time. Alternatively, if the utility program execution entry for the object indicates that the beginning stage would not be successfully executed, then at 710, a determination can be made that utility quiesce of the object is not possible and therefore, the beginning stage of the utility process would likely not be successfully executed if initiated at the selected beginning start time.

In another scenario, assume a utility program execution entry for the object was found in the utility history repository and the calculated workload at the beginning stage of the utility process was greater than the first predicted workload of the object at the selected beginning start time (e.g., on the graph). If the utility program execution entry for the object indicates that the beginning stage could be successfully executed, then at 710, a determination can be made that utility quiesce of the object is possible such that the beginning stage of the utility process would likely be successfully executed if initiated at the selected beginning start time.

In yet another scenario, assume a utility program execution entry for the object was found in the utility history repository and the calculated workload at the beginning stage of the utility process was less than the first predicted workload of the object at the selected beginning start time (e.g., on the graph). If the utility program execution entry for the object indicates that the beginning stage would not be successfully executed, then at 710, a determination can be made that utility quiesce of the object is not possible and therefore, the beginning stage of the utility process would likely not be successfully executed if initiated at the selected beginning start time.

In other scenarios, the decision as to whether utility quiesce of the object is possible may be more ambiguous (e.g., maybe). The decision may be ambiguous when there is no learned information (or actual execution information) indicating that the beginning stage of a utility process could be successfully executed contemporaneously with the first predicted workload or a workload that is greater than the first predicted workload, but there is also no learned information (or actual execution information) indicating that the beginning stage of a utility process would not be successfully executed contemporaneously with the first predicted workload or below the first predicted workload. For example, where the calculated workload in an entry is greater than the first predicted workload and the entry indicates the utility process would not be successful, or where the calculated workload in an entry is less than the first predicted workload and the entry indicates the utility process could be successful, then further evaluation of the utility process based on the workload predictions may be needed. If determinations are made that the subsequent stages (e.g., middle, end) are likely to be executed successfully, then the prediction model 146 may predict that the utility process is moderately likely to be successfully completed. If, however, determinations are made that the subsequent stages (e.g., middle, end) are likely to not be successfully executed, then prediction model 146 may predict that the utility process is unlikely to be successfully completed.

If a determination is made at 710 that a utility quiesce of the object is possible at the selected beginning start time or that may be a utility quiesce of the object is possible (and thus the beginning stage of the utility process would likely be successfully executed or maybe would be successfully executed) if initiated at the selected beginning start time, then at 712, a determination can be made as to whether keeping pace with the log writer is possible for the utility process during its middle stage based on predicted workloads that are expected to occur during the execution of the middle stage.

Object size 705 can be used to estimate the expected run time of the middle stage of the utility process. The run time is dependent on the amount of time needed to build the object (e.g., reorganize the tablespace or rebuild an index space) during the middle stage. This estimate can be done by searching utility history repository 180 for similarly sized objects and determining the amount of time that was taken to build each of the similarly sized objects when the same utility program was executed to run against the similarly sized objects. These times can be averaged to estimate the run time of the middle stage. As the utility history table is populated with more information related to actual executions, in some scenarios, the size of the object may be the same or close to the same size recorded in an entry in utility history repository 180 for a prior execution of the utility program for the object itself. In this scenario, the estimated run time of the middle stage may be based on the time recorded in that entry, or on an average of times recorded in entries for multiple actual prior executions of the utility program for the object itself.

Using the estimated run time of the middle stage and the predicted workloads for the object during the middle stage, a determination is made as to whether the utility process could keep pace with the log writer. That is, if the rate of log records being written to the log file exceeds the rate that the utility process is capable of updating the shadow object, then a determination is made that the utility process cannot keep pace with the log writer and therefore, the middle stage is not likely to be executed successfully. Alternatively, if the rate of log records being written to the log file does not exceed the rate at which the utility process is capable of updating the shadow object, then a determination is made that the utility process can keep pace with the log writer and therefore, given the current workload of the object during the middle stage, the middle stage could be successfully executed.

In at least one embodiment, the searching the utility history repository for actual execution information may be restricted to actual executions that occurred in a prior time frame that is comparable to the selected time frame 706. For example, if the selected time frame 706 is a future quiet window (e.g., next Sunday from 2 am-4 am), then the utility history repository may be searched for actual execution information that was generated for a prior quiet window (e.g., the last ten Sundays from 2 am-4 am). In some embodiments, the search may be extended to a prior time frames that are extended by a certain threshold (e.g., 1-2 hours). For example, the utility history repository may be searched for actual execution information that was generated for a 2-hour extended prior quiet window (e.g., the last ten Sundays from 12 am-6 am).

In one example, each of the predicted workloads that could occur during the estimated run time of the middle stage can be compared to a threshold rate to determine whether the utility process can keep pace with the log writer. In another example, an average of the predicted workloads during the estimated run time of the middle stage may be calculated, and the calculated average can be compared to a threshold rate to determine whether the utility process can keep pace with the log writer.

At 712, if the determination is that the middle stage of the utility process is likely to be executed successfully (e.g., the utility process can keep pace with the log writer), then at 714, a determination is made as to whether a utility quiesce is of the object is possible for the end stage of the utility process that was initiated at the selected beginning start time. An end start time (on the time-series graph) at which the end stage of the utility process is to begin may be calculated based on the selected beginning start time, an estimated run time of the beginning stage, and the estimated run time of the middle stage.

Prediction model 146 can identify a predicted workload of the object at an end start time in the time-series workload predictions (e.g., on the graph). Based on the predicted workload of the object at the end start time, prediction model 146 can search utility history repository 180 for calculated workloads on the object that are associated with the end stage of the utility process. A determination can be made at 714 as to whether a utility quiesce of the object, an update of the shadow object with the final batch of log records, and a switch of the shadow object with the live object are possible at the end start time. This determination may be based on the calculated workloads on the object and the indications of whether the end stage of the utility process could be successfully executed or not successfully executed contemporaneously with those calculated workloads.

In at least one embodiment, determining whether a utility quiesce of the object could be possible at the end start time when the end stage of the utility program would be executed may be similar to determining whether a utility quiesce of the object could be possible at the beginning start time when the beginning stage of the utility program would be executed. For example, if learned information from the utility history repository indicates that the beginning stage of a utility process executing for the object could be executed contemporaneously with the predicted workload or a workload that is greater than the predicted workload, then a determination can be made that a quiesce of the object is possible at the end start time. If learned information from the utility history repository indicates that the beginning stage of a utility process executing for the object would not be successfully executed contemporaneously with the predicted workload or a workload that is less than the predicted workload, then a determination can be made that that a quiesce of the object is not possible at the end start time. Finally, if a calculated workload in an entry is greater than the predicted workload and the entry indicates the end stage of the utility process would not be successfully executed, or if a calculated workload in an entry is less than the predicted workload and the entry indicates the end stage of the utility process could be successfully executed, then it is not known whether a quiesce of the object is possible at the end start time (i.e., maybe).

Also at 714, a determination may be made as to whether updates from a final batch of log records can be completed within a time threshold. A final batch of updates can be estimated based on the workload predictions corresponding to the execution of the middle stage. Further, a determination as to whether the shadow object can be switched with the live object can be made based on the workload prediction at the end start time and possibly subsequent to the end start time, depending on how long the file switch is expected to occur. If it is determined that changes indicated in a final batch of log records can be applied to the shadow object within time threshold 708, that the file switch can occur within the same time threshold 708, and that a quiesce of the object is possible at the end start time, then the determination is made that the end stage of the utility process is likely to be successfully executed at the end start time. If it is determined that changes indicated in a final batch of log records cannot be applied to the shadow object within time threshold 708, or that the file switch cannot occur with the same time threshold 708, or that a quiesce of the object is not possible at the end start time, then the determination is made that the end stage of the utility process is not likely to be successfully executed at the end start time. If any of the checks are determined to be ambiguous (i.e., maybe possible), then the determination could be that the end stage of the utility process has a moderate probability of being successful, but still possible.

At 716, a determination is made based on the determinations from 710, 712, and/or 714. For example, if the determinations from 710, 712, and 714 are that the beginning stage, middle stage, and end stage of a utility process could execute successfully at the beginning start time, middle start time, and end start time, respectively, then a “YES” prediction may be generated at 720, to indicate a high probability that a utility process for the object that is initiated at the beginning start time would be completed successfully. If one or more of the determinations from 710, 712, or 714 are that the beginning stage, middle stage, or end stage of a utility process would not execute successfully at the beginning start time, middle start time, or end start time, respectively, then a “NO” prediction may be generated at 720, to indicate a low probability that a utility process for the object that is initiated at the beginning start time would be completed successfully. If one or more of the determinations from 710, 712, or 714 indicate that the successful execution of the beginning stage, middle stage, or end stage of a utility process at the beginning start time, middle start time, and end start time, respectively, is ambiguous, then a “MAYBE” prediction may be generated at 720 to indicate a moderate probability that a utility process for the object that is initiated at the beginning start time would be completed successfully. Generally, to generate a “MAYBE” prediction, none of the determinations of the stages indicates that that stage is unlikely to be executed successfully, and at least one of the determinations of the stages indicates that whether the stage will be completed successfully is unknown.

As described above, in the processing of prediction model 146, the utility history repository 180 may be searched at each of the process stage checks (e.g., beginning 710, middle 712, end 714). The above flow was generally described as searching for and applying learned information that may have been generated as the result of utility reporting program 137. However, as time passes and actual executions are performed, utility program execution entries for actual (real) executions of the utility program may be added to utility history repository 180, for example, at 570. These entries may contain information related to the actual executions of the utility program. Thus, when searching for relevant information, at least some of the information may be derived from actual executions.

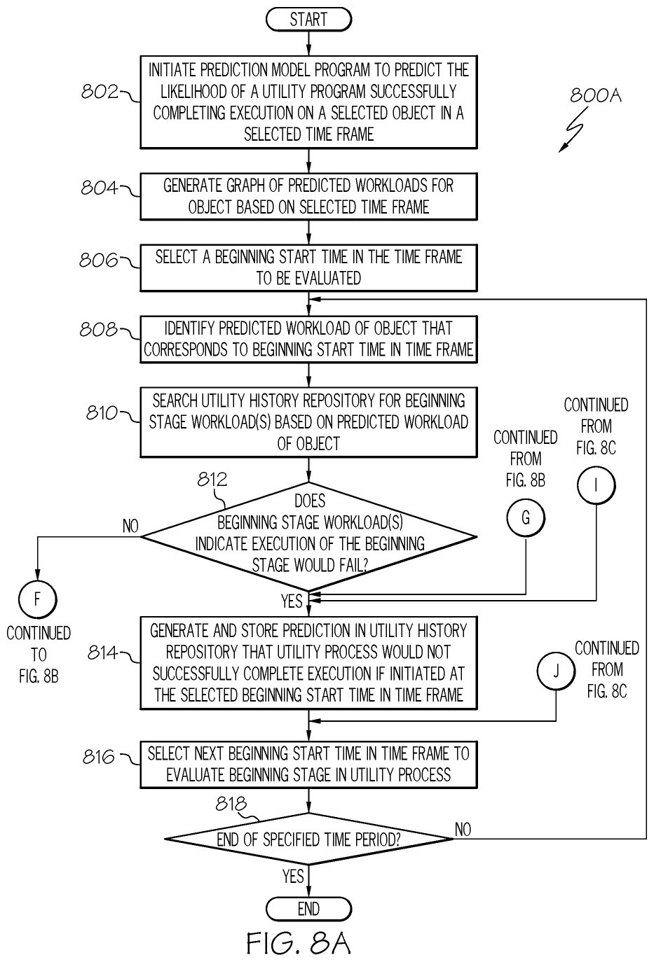

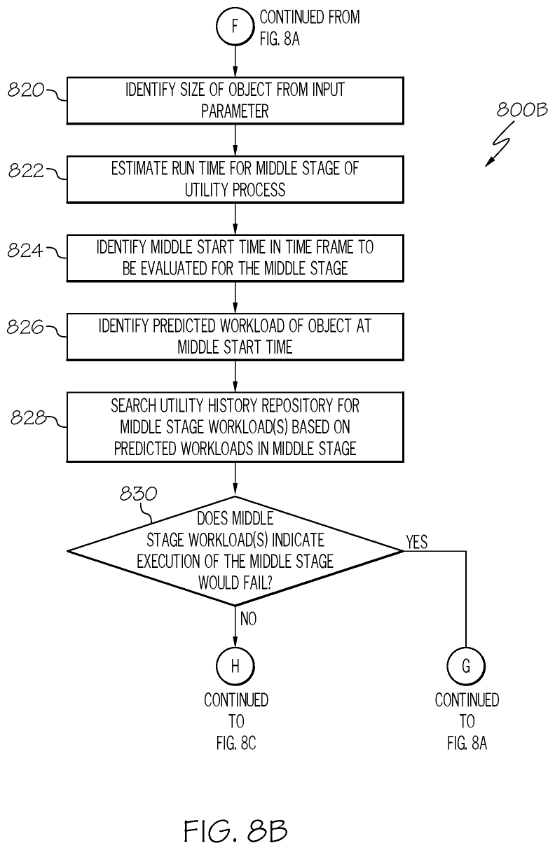

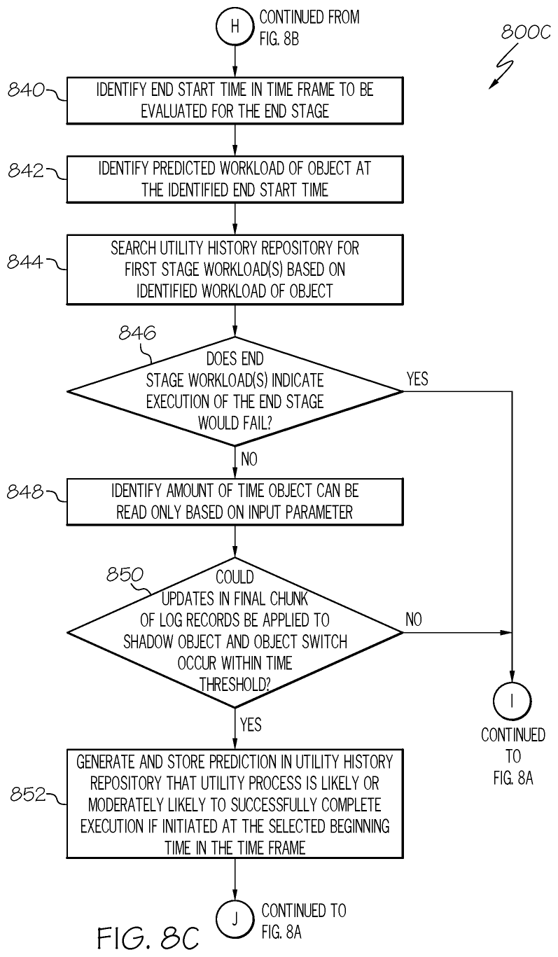

FIGS. 8A, 8B, and 8C show flowcharts 800A, 800B, and 800C, respectively, which illustrate example techniques related to one or more embodiments of a communication system, such as communication system 100. In at least one embodiment, one or more sets of operations correspond to the activities of FIGS. 8A-8C predicting whether a database utility program can be initiated and successfully completed within a specified time frame. In one example, a machine learning server (e.g., 140), or a database server (e.g., 130), or portions thereof, may perform at least some of the operations in the one or more sets of operations. The machine learning server may comprise means, such as processor 149 and memory 148, for performing at least some of the operations. In an embodiment, one or more operations of flowcharts 800A, 800B, and 800C may be performed by a prediction model (e.g., 146). The database server may comprise means, such as processor 139 and memory 138, for performing at least some of the operations. In an embodiment, one or more operations of flowcharts 800A, 800B, and 800C may be performed by a time-series workload model (e.g., 136).

Flowchart 800A generally shows a flow for determining whether a beginning stage of a database utility process could be successfully executed at a beginning start time within a specified time frame. At 802, the prediction model is initiated to predict whether a selected utility program (e.g., reorg utility program 131A or rebuild utility program 131B) can successfully complete executing for a selected object (e.g., tablespace 122 or index space 124) in a selected time frame.

The prediction model may receive several input parameters related to a utility program, an object, and a time frame that are selected (e.g., by a user or automated process). The input parameters may include, for example, a utility program identifier, an object identifier, an object size, a time frame, and a time threshold. The prediction model may provide the selected time frame and the object identifier to a time-series workload model trained to generate workload predictions for the selected object. At 804, the time-series workload model generates predicted workloads for the object based on the time frame. In at least one embodiment, the predicted workloads may be plotted on a graph against the time frame.

At 806, the prediction model may select a beginning start time in the time frame to be evaluated. At 808, a first predicted workload of the object, which corresponds to the selected beginning start time in the time frame, may be identified. It should be apparent that the selected beginning start time may or may not be the first time of the time frame, but rather, the beginning start time is any time within the time frame that is selected for evaluating whether the beginning stage of the utility process could successfully execute at that beginning start time.

At 810, a utility history repository (e.g., 180) may be searched for utility program execution entries with learned information about the success and failure of utility processes that includes indications of whether the beginning stage of a utility process would be successfully executed or not on the selected object and the calculated workload on the object for the beginning stage of that execution.

At 812, a determination is made as to whether the beginning stage calculated workloads found in the utility history repository indicate that an execution of the beginning stage would fail if executed at the selected beginning start time in the time frame. If it is determined at 812 that the execution of the beginning stage would fail, then at 814, a “NO” prediction may be generated to indicate a low probability that the utility program would successfully complete execution if it was initiated at the selected beginning start time.

Additionally, the “NO” prediction may be stored in an entry of the utility history repository together with the beginning start time, an identifier of the utility program, and an identifier of the object. If the utility program is subsequently executed at the beginning start time, then the entry in the utility history repository that contains the prediction may be updated with the results of the execution (e.g., “SUCCESSFUL” or “UNSUCCESSFUL/FAIL”). These results can help the prediction model to make more accurate predictions, particularly when the prediction model evaluates the same utility program being executed for the same object in a new future time frame.

At 816, a next beginning start time in the time frame is selected to begin evaluating the utility process at the newly selected time in the time frame. In at least one embodiment, the prediction model may use the results from 812 to guide the selection of the next beginning start time to be evaluated. For example, if the predicted workloads at subsequent times in the time frame are the same or within a certain range of the predicted workload at the beginning start time in the time frame, then those subsequent times may be ignored or skipped when selecting the next beginning start time to be evaluated.

At 818, a determination may be made as to whether the prediction model has reached the end of the specified time frame to be evaluated. If the end of the selected time frame has been reached, then at 818, the prediction model flow may end. If the end of the selected time frame has not been reached, then the flow may loop back to 808, to identify the next predicted workload at the newly selected beginning start time to begin evaluating the utility process at the newly selected time in the time frame.

If it is determined at 812 that the beginning stage workloads from the utility history repository do not indicate that the execution of the beginning stage will fail (e.g., a determination that successful beginning stage execution is likely or unknown), then flow may pass to FIG. 8B. Flowchart 800B generally shows a flow for determining whether a middle stage of a database utility process could be successfully executed at a middle start time within a specified time frame.

At 820, a size of the selected object is identified from an input parameter. At 822, a determination is made as to an amount of time it will take the utility process to build the object (e.g., reorganize the tablespace or rebuild an index space) in the middle stage of the utility process. The run time of the middle stage may be estimated as previously described herein.

At 824, a middle start time in the time frame can be identified to evaluate the middle stage. For example, the middle start time may be a time in the time frame subsequent to the beginning start time if the workload predictions are generated with short spacing between their corresponding times (e.g., 1 second, 2 second, etc.). In other implementations, where the workload predictions are generated with longer spacing between their corresponding times (e.g., 10 seconds, 12 seconds, etc.), the middle start time may be the same as the beginning start time.

At 826, a predicted workload of the object, which corresponds to the selected middle start time in the time frame, may be identified.

At 828, a utility history repository (e.g., 180) may be searched for utility program execution entries with learned information that includes indications of whether the middle stage of a utility process could be successfully executed or not on the selected object and the calculated workload on the object for the middle stage of that execution. At 830, a determination is made as to whether the middle stage calculated workloads found in the utility history repository indicate that an execution of the middle stage would fail if executed at the middle start time in the time frame.

If it is determined at 830 that the middle stage workloads from the utility history repository indicate that the execution of the middle stage would fail, then flow may then pass back to FIG. 8A at 814, where a prediction may be generated that the utility process could not execute successfully if initiated at the selected beginning start time. Flow may continue in FIG. 8A to select the next beginning start time in the time frame to continue trying to identify times in the time frame where a utility process may be successful.

If it is determined, at 830, that the middle stage workloads from the utility history repository do not indicate that the execution of the middle stage would fail (e.g., a determination that successful middle stage execution is likely or unknown), then flow may pass to FIG. 8C. Flowchart 800C generally shows a flow for determining whether an end stage of a database utility process could be successfully executed at an end start time within a specified time frame.

At 840, an end start time in the time frame can be identified to evaluate the end stage of the utility process. For example, the end start time may be a time in the time frame subsequent to the middle start time if the estimated run time of the middle stage is longer than the spacing between consecutive workload predictions. In one example, the end start time may be calculated by adding the estimated run time of the middle stage to the middle start time.

At 842, a predicted workload of the object, which corresponds to the selected end start time in the time frame, may be identified.

At 844, a utility history repository (e.g., 180) may be searched for utility program execution entries with learned information that includes indications of whether the end stage of a utility process could be successfully executed or not on the selected object and the calculated workload on the object for the end stage of that execution.

At 846, a determination is made as to whether the end stage calculated workloads found in the utility history repository indicate that an execution of the end stage would fail if executed at the beginning start time in the time frame. If it is determined, at 846, that the end stage workloads indicate that execution of the end stage would fail, then flow continues in FIG. 8A at 814, where a prediction may be generated that the utility program would not successfully complete execution if initiated at the selected beginning start time.

If it is determined at 846 that the end stage workloads do not indicate that execution of the end stage would fail (e.g., a determination that successful end stage execution is likely or unknown), then at 848, a time threshold (e.g., amount of time the object can be in a read-only state) is determined based on an input parameter.

At 850, a determination is made as to whether updates from a final batch of log records and subsequent object switch could be completed within the time threshold, as previously described herein. If the updates could not be applied to the shadow object and the object switch made within the time threshold, then the utility process could time out, so flow passes to FIG. 8A at 814, where a prediction may be generated that the utility program would not successfully complete execution if initiated at the selected beginning start time.

If it is determined, at 850, that updates from a final batch of log records and an object switch could be completed within the time threshold, then at 852, a “YES” prediction or a “MAYBE” prediction may be generated to indicate a high probability or a moderate probability, respectively, that a utility process for the object would successfully complete if initiated at the selected beginning start time in the time frame. The prediction may be a “YES” prediction if each stage of the utility process is determined to be likely to execute successfully. The prediction may be a “MAYBE” prediction if an outcome of at least one of the stages of the utility process is determined to be ambiguous (or unknown) and if none of the stages of the utility process are determined to be likely to fail.

Additionally, the “YES” or “MAYBE” prediction may be stored in an entry of the utility history repository together with the beginning start time, an identifier of the utility program, and an identifier of the object. If the utility program is subsequently executed at the beginning start time in response to the prediction, then the entry in the utility history repository that contains the prediction may be updated with the results of the execution (e.g., “SUCCESSFUL” or “UNSUCCESSFUL/FAIL”). These results can help the prediction model to make more accurate predictions when the prediction model evaluates the same utility program being executed for the same object in a new future time frame.

After generating the prediction, flow may pass to FIG. 8A at 816, where a next beginning start time in the time frame is selected to begin evaluation of the beginning stage in the utility process again. At 818, a determination may be made as to whether the prediction model has reached the end of the specified time frame to be evaluated. If so, then prediction model may end. If not, then the flow passes back to 808, to continue evaluating times in the time frame to find each time at which the utility process may be run with a likelihood of completing the execution.

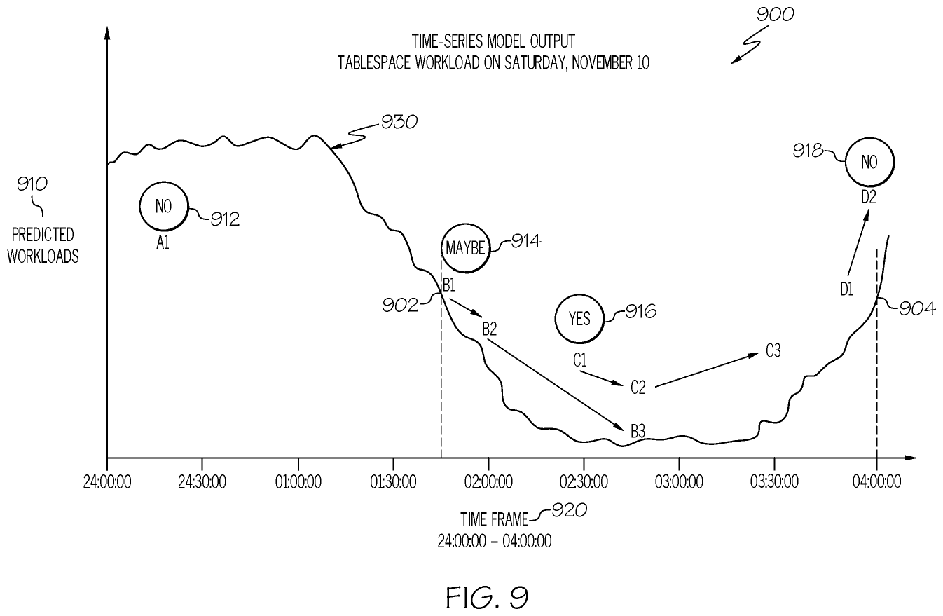

FIG. 9 is graph 900 that illustrates an example output of the prediction model based on a selected utility program, a selected object, and a selected time. The selected time frame in the example of FIG. 9 is 12 am-4 am on a Saturday in the future (e.g., Saturday, November 10). In this example, the selected object is a tablespace, such as tablespace 122, and the selected utility program is a reorganization utility program, such a reorg utility program 131A. Graph 900 shows the output from a time-series workload model for the object (e.g., tablespace workload model 315). The output is shown as a plot 930 of the values that represent the object's predicted workloads 910 (y-axis) against time in a selected time frame (x-axis) 920.

As seen in graph 900, plot 930 shows a very high workload for tablespace 122 between 12 am and approximately 1:15 am. The workload then begins to fall until it reaches its lowest level at around 2:40 am. The workload then begins to increase again around 3:30 am and continues increasing until the end of the time frame at 4 am. Points 902 and 904 are marked on plot 930 to indicate the threshold workload above which a reorg utility process does not typically complete successfully, and below which the reorg utility process typically does complete successfully.

Prediction model 146 can use the workload predictions of the time-series workload model, as shown in plot 930, to determine where in time frame 920 the reorg utility program 131A can be executed such that the instantiated reorg utility process is successfully completed (e.g., finishes execution without ending abnormally). In the example of FIG. 9, a reorg utility process that is run for tablespace 122 may be successfully completed if the process runs between 1:30 am and 4:00 am.

Four possible predictions generated by prediction model 146 are illustrated in FIG. 9. A plotted first prediction 912 shows a beginning stage A1 of a possible reorg utility process for the tablespace. The beginning stage A1 is well above the workload threshold points 902, 904 and, therefore, a prediction is generated that indicates a low probability that a reorg utility process for tablespace 122 would complete successfully if it was initiated at the start time evaluated for beginning stage A1 (e.g., 24:15:00).

A plotted second prediction 914 shows a beginning stage B1, a middle stage B2, and an end stage B3 of a possible reorg utility process for tablespace 122. The beginning stage B1 is slightly above workload threshold point 902 but could be within a threshold range of the workload threshold point 902. Middle stage B2 is below the workload threshold point 902, but may also be within the workload threshold range of workload threshold point 902. End stage B3, however, is well below the workload threshold points 902, 904. Therefore, in this example, the prediction model determined that beginning stage B1 and middle stage B2 would each “maybe” execute successfully if the reorg utility process was initiated at the time evaluated for the beginning stage B1 (e.g., 01:50:00). Because two stages had an ambiguous prediction of successful execution, a prediction is generated that indicates a moderate probability that the reorg utility process would complete successfully if it was initiated at the start time evaluated for the beginning stage B1 (e.g., 01:50:00).

A plotted third prediction 916 shows a beginning stage C1, a middle stage C2, and an end stage C3 of a possible reorg utility process for tablespace 122. All of the stages are well below the workload threshold points 902, 904. Accordingly, the prediction model generates a prediction that indicates a high probability that a reorg utility process for tablespace 122 would complete successfully if it was initiated at the start time evaluated for beginning stage C1 (e.g., 02:30:00).

A plotted fourth prediction 918 shows a beginning stage D1 and a middle stage D2 of a possible reorg utility process for tablespace 122. The beginning stage D1 is within a threshold range of the workload threshold point 904. Middle stage D2, however, is well above the workload threshold from workload point 904. Therefore, the prediction model determined that beginning stage D1 would “maybe” execute successfully if the reorg utility process was initiated at the time evaluated for the beginning stage D1 (e.g., 03:50:00). Thus, prediction model continued evaluating stages of a possible reorg utility process and determined that middle stage D2 would be well above the workload threshold point 904, and therefore, would not execute successfully. Accordingly, the prediction model generates a predication that indicates a low probability that the reorg utility process would complete successfully if it is initiated at the time evaluated for beginning stage D1 (e.g., 03:50:00).

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed sequentially, substantially concurrently, or in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that all variations of the terms “comprise,” “include,” and “contain,” when used in this specification, specify the presence of stated features, integers, steps, operations, elements, and/or components, but do not preclude the presence or addition of one or more other features, integers, steps, operations, elements, components, and/or groups thereof.

As used herein, unless expressly stated to the contrary, use of the phrase ‘at least one of’ and ‘one or more of’ refers to any combination of the named elements, conditions, or activities. For example, ‘at least one of X, Y, and Z’ is intended to mean any of the following: 1) at least one X, but not Y and not Z; 2) at least one Y, but not X and not Z; 3) at least one Z, but not X and not Y; 4) at least one X and at least one Y, but not Z; 5) at least one X and at least one Z, but not Y; 6) at least one Y and at least one Z, but not X; or 7) at least one X, at least one Y, and at least one Z. Also, references in the specification to “one embodiment,” “an embodiment,” “some embodiments,” etc., indicate that the embodiment(s) described may include a particular feature, structure, or characteristic, but every embodiment may or may not necessarily include that particular feature, structure, or characteristic. Moreover, such phrases are not necessarily referring to the same embodiment. Additionally, unless expressly stated to the contrary, the terms ‘first’, ‘second’, ‘third’, etc., are intended to distinguish the particular noun (e.g., element, condition, module, activity, operation, claim element, etc.) they modify, but are not intended to indicate any type of order, rank, importance, temporal sequence, or hierarchy of the modified noun. For example, ‘first X’ and ‘second X’ are intended to designate two separate X elements, that are not necessarily limited by any order, rank, importance, temporal sequence, or hierarchy of the two elements.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method, comprising:
generating predicted workloads on an object within a time frame;
identifying a first predicted workload on the object at a first time in the time frame;
determining, based on the first predicted workload of the object, whether a first stage of a utility process can be successfully executed for the object at the first time; and
based, at least in part, on determining whether the first stage can be successfully executed at the first time, making a prediction related to whether the utility process can be successfully completed when the utility process is initiated at the first time.

2. The method of claim 1, further comprising:
searching a utility history repository for an entry containing previously learned information related to the first stage of the utility process, wherein the previously learned information includes a calculated workload of the object.

3. The method of claim 2, further comprising:
determining that the first stage can be executed successfully at the first time based on:
determining that the entry contains an indication that the first stage can be successfully executed contemporaneously with the calculated workload; and
determining that the first predicted workload is the same as or less than the calculated workload.

4. The method of claim 2, further comprising:
determining that the first stage cannot be executed successfully at the first time based on:
determining that the entry contains an indication that the first stage cannot be successfully executed contemporaneously with the calculated workload; and
determining that the first predicted workload is the same as or more than the calculated workload.

5. The method of claim 2, further comprising:
determining that the first stage has a moderate probability of being successfully executed at the first time based on:
determining that the entry contains an indication that the first stage can be successfully executed contemporaneously with the calculated workload; and
determining that the first predicted workload is greater than the calculated workload and less than a threshold value from the calculated workload.

6. The method of claim 1, wherein the prediction indicates that, when initiated at the first time, the utility process has a low probability of successful completion based on determining that the first stage cannot be successfully executed contemporaneously with a previously calculated workload that is the same as or less than the first predicted workload.

7. The method of claim 1, wherein the prediction indicates that, when initiated at the first time, the utility process has a moderate probability of successful completion based, in part, on determining that whether the first stage can execute successfully when executing contemporaneously with the first predicted workload is unknown.

8. The method of claim 1, wherein the prediction indicates that, when initiated at the first time, the utility process has a high probability of successful completion based on:
determining that the first stage can be executed successfully when executed contemporaneously with the first predicted workload at the first time;
determining that a second stage of the utility process can be executed successfully when executed contemporaneously with one or more predicted workloads associated with a second time in the time frame; and
determining that a third stage can be executed successfully when executed contemporaneously with a third predicted workload at a third time in the time frame.

9. The method of claim 1, further comprising:
identifying a second predicted workload on the object at a second time in the time frame; and
determining, based on the second predicted workload of the object, whether a second stage of the utility process can be successfully executed for the object at the second time,
wherein the prediction is based, in part, on determining whether the second stage of the utility process can be successfully executed for the object at the second time.

10. The method of claim 9, further comprising:
identifying a third predicted workload on the object at a third time in the time frame; and
determining, based on the third predicted workload of the object, whether a third stage of the utility process can be successfully executed for the object at the third time,
wherein the prediction is based, in part, on determining whether the third stage of the utility process can be successfully executed for the object at the third time.

11. The method of claim 1, wherein the predicted workloads are generated from an AutoRegressive Integrated Moving Average (ARIMA) model, wherein the ARIMA model is created from log records of transactions performed on the object.

12. The method of claim 1, wherein the object is either a tablespace of a database or an index space of the database.

13. The method of claim 12, wherein the utility process is associated with one of a utility program to reorganize the tablespace or another utility program to rebuild the index space.

14. A non-transitory computer readable medium comprising program code that is executable by a computer system to perform operations comprising:
generating predicted workloads on an object within a time frame;
identifying a first predicted workload on the object at a first time in the time frame;
identifying a calculated workload on the object that is associated with previously learned information related to a first stage of a utility process for the object;
based, at least in part, on comparing the first predicted workload to the calculated workload, determining whether the first stage can be successfully executed at the first time; and
generating a prediction indicating whether the utility process can be successfully completed based, at least in part, on whether the first stage can be successfully executed at the first time.

15. The non-transitory computer readable medium of claim 14, wherein the program code is executable by the computer system to perform further operations comprising:
creating a time-series workload model to generate the predicted workloads of the object within the time frame, wherein the time-series workload model is created from log records of transactions performed on the object.

16. The non-transitory computer readable medium of claim 14, wherein the program code is executable by the computer system to perform further operations comprising:
simulating an execution of the first stage of the utility process for the object;
generating the calculated workload based on an actual workload on the object during the simulated execution;
determining the first stage of the utility process cannot be successfully executed based on the simulated execution failing; and
storing, in a utility history repository, the calculated workload and an indication that the first stage of the utility process could not be successfully executed contemporaneously with the calculated workload on the object.

17. The non-transitory computer readable medium of claim 14, wherein the first stage of the utility process is one of a beginning stage, a middle stage, or an end stage of the utility process.

18. An apparatus comprising:
a processor; and
a time-series workload model including first instructions that are executable by the processor to generate predicted workloads of an object within a time frame;
a prediction model including second instructions that are executable by the processor to:
identify a first predicted workload on the object at a first time in the time frame;
determine, based on the first predicted workload of the object, that a first stage of a utility process cannot be successfully executed for the object at the first time;
identify a second predicted workload on the object at a second time within the time frame; and
based, at least in part, on determining whether the first stage can be successfully executed at the second time, generate a prediction related to whether the utility process can be successfully executed when the first stage is executed at the second time.

19. The apparatus of claim 18,
wherein the object is either a tablespace of a database or an index space of the database, and
wherein the utility process is associated with one of a first utility program to reorganize the tablespace or a second utility program to rebuild the index space.

20. The apparatus of claim 18, wherein the second instructions are executable by the processor to further:
search a utility history repository for previously learned information related to the first stage of the utility process, wherein the previously learned information includes a calculated workload of the object; and
determine whether the first stage can be successfully executed at the second time based on:
a comparison of the second predicted workload and the calculated workload; and
an indication of whether the first stage can be successfully executed contemporaneously with the calculated workload.
